(19) United States
(12) Patent Application Publication
(10) Pub. No.: US 2026/0320777 A1
(43) Pub. Date: Oct. 15, 2026

(54) SCREEN DAMAGE ASSESSMENT SYSTEM FOR MOBILE DEVICES

(71) Applicant: Apkudo, Inc., Baltimore, MD (US)

(72) Inventor: Joshua S. MATTHEWS, Baldwin, MD (US)

(21) Appl. No.: 19/644,658

(22) Filed: Apr. 10, 2026

Related U.S. Application Data
(60) Provisional application No. 63/787,568, filed on Apr. 11, 2025.

(51) Int. Cl. G06T 7/00; G06V 10/98

(52) U.S. Cl. CPC G06T 7/001; G06V 10/993

(57) ABSTRACT

A method of assessing screen damage on a device comprises displaying a pattern on a screen of the device. The method further comprises causing a camera to capture one or more images of the pattern displayed on the screen. Based on the one or more captured images, the method comprises determining a defect is present on the screen. The method further comprises communicating an indication of the defect. Systems and computer storage media for performing the method are also provided.

### CROSS-REFERENCE TO RELATED APPLICATIONS

This application claims priority to U.S. Application No. 63/787,568, titled IDENTIFYING MOBILE DEVICE SCREEN DAMAGE, filed Apr. 11, 2025, which is hereby incorporated by reference in its entirety.

### FIELD OF INVENTION

The present disclosure relates to automated assessment of mobile device screens, and more particularly to a system and method for detecting screen defects on mobile devices by displaying patterns, capturing images of the patterns, and analyzing deviations from reference images to determine the presence and characteristics of screen damage.

### BACKGROUND

Mobile devices have become an integral part of daily life, serving as communication tools, sources of entertainment, and productivity aids. Many such devices, including smartphones, tablets, laptops, and similar electronic equipment, incorporate display screens to facilitate user interaction and information presentation. Advancements in hardware and software technologies have significantly enhanced the capabilities of these mobile devices, with manufacturers routinely releasing new models that lead to frequent device upgrades by users. Older devices, while often still functional, are commonly replaced and subsequently resold or reused in secondary markets. The physical condition of these devices, particularly the condition of their display screens, may affect their resale value and continued utility.

The screens of mobile devices are prone to various types of damage resulting from daily wear and tear, including handling, dropping, and exposure to environmental conditions such as moisture, dust, and extreme temperatures. Common screen defects include cracks, scratches, smudges, dead pixels, light bleeding, bright spots, and screen burn. While deep cracks may be visible to the human eye, smaller imperfections such as hairline cracks, minor scratches, and subtle smudges can be difficult to detect through visual inspection alone.

Conventional techniques for assessing screen damage include manual inspection methods such as magnification, backlight tests, dead pixel tests, and pressure tests. Magnification techniques may enhance visibility of micro-cracks and tiny scratches. Backlight tests may help identify uneven lighting, dark spots, or backlight bleeding. Dead pixel tests, which involve displaying solid colors on a screen, may help identify non-functional pixels. Pressure tests involve applying pressure to different parts of the screen to identify areas showing signs of damage. However, these conventional techniques are often performed individually and manually, which can be time-consuming and prone to human error. Manual inspection relies on the skill and attention of the technician, and certain assessment tests are subjective in nature, leading to variability in outcomes from person to person.

Environmental factors such as lighting, reflections, and shadows can inconsistently obscure or highlight defects, further complicating screen assessment and defect determination. Many defects have low contrast against the screen’s background, making them difficult to spot with visual inspection and other conventional techniques. Additionally, conventional techniques typically require a skilled person having physical possession of a mobile device to diagnose screen defects, which may be inconvenient or impossible when the mobile device cannot be physically presented to the technician. Transporting mobile devices from one location to a technician for assessment requires expenditure of resources and time.

Developing automated systems that can accurately determine whether cosmetic and functional defects are present on a screen presents technical challenges, as such systems may need to work across a wide range of issues and device types. Grading devices for redistribution and reuse involves assessing their condition and accurately conveying that condition to downstream parties. Manual grading often involves subjective assessments, which can lead to variability in assigned grades, and there is no universal standard for grading used mobile devices, leading to inconsistencies in grading criteria. Accordingly, improved systems and methods for assessing screen damage on mobile devices are desired.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a method of assessing screen damage on a device is provided. The method comprises displaying a pattern on a screen of the device. The method further comprises causing a camera to capture one or more images of the pattern displayed on the screen. Based on the one or more captured images, the method comprises determining a defect is present on the screen. The method further comprises communicating an indication of the defect.

According to other aspects of the present disclosure, the method may include one or more of the following features. The method may further comprise displaying an optical code on the screen, matching the optical code to a subject device, and determining the screen of the device corresponds to the subject device. The pattern may be displayed after determining the screen of the device corresponds to the subject device. The pattern may comprise a solid color. The pattern may comprise a transition between one or more colors. The pattern may comprise black and white squares. The pattern may comprise text in various fonts and sizes. The pattern may comprise geometric shapes. The pattern may comprise one or more lines. The pattern may be a grid. The method may further comprise normalizing the pattern to determine a baseline. The pattern may be rotated on the screen. The one or more images of the pattern may be captured using a camera of the device on which the pattern is displayed. The camera may be a front-screen camera located on a front of the device. The camera may capture the one or more images by capturing a reflection of the pattern. The one or more images of the pattern may be captured using a camera that is an external camera not located on the device. Each image of the one or more images of the pattern may be compared to each reference image of a plurality of reference images. The plurality of reference images may represent the screen without the defect. The method may further comprise determining the one or more images of the pattern exceed a deviation threshold, wherein the deviation threshold corresponds to a perturbation in the one or more images of the pattern. The perturbation may be a deviation from at least one of the reference images. The method may further comprise determining there is a deviation between the one or more images of the pattern and one or more of the reference images, and based on the deviation exceeding the deviation threshold, communicating the indication of the defect. The defect may be determined based on the perturbation being a change in color within the one or more images of the pattern. The defect may be determined based on the perturbation being a refraction of light off the screen. The indication of the defect on the screen may comprise a cracked screen, a scratched screen, a smudge on the screen, or one or more dead pixels on the screen. The method may further comprise determining the defect on the screen using artificial intelligence. Communicating the indication of the defect may comprise recommending a course of action based on the defect. The course of action may comprise buffing out one or more scratches, cleaning one or more smudges, replacing the screen, providing a valuation for the device, or determining an insurability of the device.

According to another aspect of the present disclosure, one or more computer storage media having computer-executable instructions embodied thereon are provided. The computer-executable instructions, when executed by one or more processors, cause the one or more processors to perform operations comprising accessing one or more images of a pattern displayed on a screen of a device and captured by a camera. The operations further comprise determining there is a deviation between the one or more images of the pattern and at least one reference image of a plurality of reference images. Based on the deviation exceeding a deviation threshold, the operations comprise determining a defect is present on the screen. The operations further comprise communicating an indication of the defect.

According to other aspects of the present disclosure, the one or more computer storage media may include one or more of the following features. The operations may further comprise displaying an optical code on the screen, matching the optical code to a subject device, and determining the screen of the device corresponds to the subject device. The one or more images of the pattern may be accessed after determining the screen corresponds to the subject device. The pattern may comprise a solid color. The pattern may comprise a transition between one or more colors. The pattern may comprise black and white squares. The pattern may comprise text in various fonts and sizes. The pattern may comprise geometric shapes. The pattern may comprise one or more lines. The pattern may be a grid. The camera may be a front-screen camera located on a front of the device. The camera may capture the one or more images of the pattern by capturing a reflection of the pattern. The camera may be an external camera not located on the device. Each image of the one or more images of the pattern may be compared to each reference image of the plurality of reference images. The plurality of reference images may represent the screen without the defect. The operations may further comprise determining the one or more images of the pattern exceed a deviation threshold, wherein the deviation threshold corresponds to a perturbation in the one or more images of the pattern. The perturbation may be a deviation from at least one of the reference images. The defect may be determined based on the perturbation being a change in color within the one or more images of the pattern. The defect may be determined based on the perturbation being a refraction of light off the screen. The indication of the defect on the screen may comprise a cracked screen, a scratched screen, a smudge on the screen, or one or more dead pixels on the screen. The operations may further comprise determining the defect in the screen using artificial intelligence. Communicating the indication of the defect may comprise recommending a course of action based on the defect. The course of action may comprise buffing out one or more scratches, cleaning one or more smudges, replacing the screen, providing a valuation for the device, or determining an insurability of the device.

According to another aspect of the present disclosure, a system is provided. The system comprises a device, a front-screen camera on the device, at least one processor, and one or more computer storage media storing computer readable instructions thereon. The computer readable instructions, when executed by the at least one processor, cause the at least one processor to perform operations comprising displaying a pattern on a screen of the device. The operations further comprise capturing an image of the screen using the front-screen camera. Based on the image, the operations comprise determining a defect is present on the screen. The operations further comprise communicating an indication of the defect.

According to other aspects of the present disclosure, the system may include one or more of the following features. The operations may further comprise displaying an optical code on the screen, matching the optical code to a subject device, and determining the screen of the device corresponds to the subject device. The pattern may be displayed on the screen after determining the device corresponds to the subject device. The pattern may comprise a solid color. The pattern may comprise a transition between one or more colors. The pattern may comprise black and white squares. The pattern may comprise text in various fonts and sizes. The pattern may comprise geometric shapes. The pattern may comprise one or more lines. The pattern may be a grid. The operations may further comprise normalizing the pattern to determine a baseline. The pattern may be rotated on the screen. The front-screen camera may capture the image of the screen by capturing a reflection of the screen in a mirror. The image of the screen may comprise a plurality of frames, and each frame of the plurality of frames may be compared to each reference image of a plurality of reference images. The plurality of reference images may represent the device without the defect. The operations may further comprise determining the image exceeds a deviation threshold, wherein the deviation threshold corresponds to a perturbation in the image. The perturbation may be a deviation from at least one of the reference images. The operations may further comprise determining there is a deviation between at least one frame of the plurality of frames and at least one reference image of the plurality of reference images, and based on the deviation exceeding the deviation threshold, communicating the indication of the defect. The defect may be determined based on the perturbation being a change in color within the pattern on the screen. The defect may be determined based on the perturbation being a refraction of light off the screen. The indication of the defect may comprise a cracked screen, a scratched screen, a smudge on the screen, or one or more dead pixels on the screen. The operations may further comprise determining the defect using artificial intelligence. The artificial intelligence may recommend a course of action based on the defect. The course of action may comprise buffing out one or more scratches, cleaning one or more smudges, replacing the screen, providing a valuation for the device, or determining an insurability of the device.

According to another aspect of the present disclosure, a method of assessing screen damage on a device is provided. The method comprises capturing one or more images of a pattern displayed on a screen of a device. The method further comprises determining there is a deviation between the one or more captured images and one or more reference images of a plurality of reference images. Based on the deviation exceeding a deviation threshold, the method comprises determining a defect is present on the screen. The method further comprises communicating an indication of the defect.

According to other aspects of the present disclosure, the method may include one or more of the following features. The method may further comprise capturing an optical code displayed on the screen, matching the optical code to a subject device, and determining the screen of the device corresponds to the subject device. The one or more images of the pattern may be captured after determining the device corresponds to the subject device. The pattern may comprise a solid color. The pattern may comprise a transition between one or more colors. The pattern may comprise black and white squares. The pattern may comprise text in various fonts and sizes. The pattern may comprise geometric shapes. The pattern may comprise one or more lines. The pattern may be a grid. The one or more images of the pattern may be captured from a distance from the device. The one or more captured images may be compared to each reference image of a plurality of reference images. The plurality of reference images may represent the device without the defect. The method may further comprise determining the one or more captured images exceed a deviation threshold, wherein the deviation threshold corresponds to a perturbation in the one or more images of the pattern. The perturbation may be a deviation from at least one of the reference images. The defect may be determined based on the perturbation being a change in color within the pattern displayed on the screen. The defect may be determined based on the perturbation being a refraction of light off the screen. The indication of the defect may comprise a cracked screen, a scratched screen, a smudge on the screen, or one or more dead pixels on the screen. The method may further comprise determining the defect using artificial intelligence. The artificial intelligence may recommend a course of action based on the defect. The course of action may comprise buffing out one or more scratches, cleaning one or more smudges, replacing the screen, providing a valuation of the device, or determining an insurability of the device.

The foregoing general description of the illustrative embodiments and the following detailed description thereof are merely exemplary aspects of the teachings of this disclosure and are not restrictive.

### BRIEF DESCRIPTION OF FIGURES

The present technology is described in detail below with reference to the attached drawing figures, wherein:

FIG. 1 illustrates a block diagram of an example operating environment, according to aspects of the present disclosure.

FIG. 2 illustrates an example user device suitable for use by aspects of the technology.

FIG. 3 illustrates an example of optical codes rendered on a display, according to an embodiment.

FIG. 4A illustrates an example pattern rendered on a display at a first orientation, according to aspects of the present disclosure.

FIG. 4B illustrates an example pattern rendered on a display at a second orientation, according to aspects of the present disclosure.

FIG. 4C illustrates an example pattern rendered on a display at a third orientation, according to aspects of the present disclosure.

FIG. 4D illustrates an example pattern rendered on a display at a fourth orientation, according to an embodiment.

FIG. 4E illustrates an example pattern rendered on a display at a fifth orientation, according to an embodiment.

FIG. 5 illustrates an example of a pattern captured by a front-screen camera using a mirror, according to aspects of the present disclosure.

FIG. 6 illustrates an example of a pattern captured by an external camera, according to an embodiment.

FIG. 7 illustrates an example of a defect determiner for determining defects on a screen, according to aspects of the present disclosure.

FIG. 8 illustrates an example of an indication communicator communicating an indication of a defect, according to an embodiment.

FIG. 9 illustrates a flowchart for a method for assessing screen damage on a device, according to aspects of the present disclosure.

FIG. 10 illustrates a flowchart for a method for assessing screen damage on a device, according to an embodiment.

FIG. 11 illustrates a flowchart for a method for assessing screen damage on a device, according to aspects of the present disclosure.

FIG. 12 illustrates a flowchart for a method for assessing screen damage on a device, according to an embodiment.

FIG. 13 illustrates a block diagram of an example computing device suitable for implementing aspects of the technology.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure relates to systems and methods for automated assessment of screens on mobile devices. Mobile devices have become ubiquitous tools for communication, productivity, and entertainment, and the screens of these devices are prone to various types of damage such as cracks, scratches, smudges, and dead pixels. Daily wear and tear from handling, dropping, and exposure to environmental conditions can cause physical damage that affects device functionality, aesthetic appeal, and resale value. Determining whether screen defects exist and assessing the nature of such defects may be performed to maintain device value and to facilitate decisions regarding repair, replacement, or resale.

Traditional approaches to screen assessment involve manual inspection by technicians, which may be time-consuming and prone to human error. Manual inspection relies on the skill and attention of the technician, and certain assessment tests are subjective in nature, leading to variability in outcomes. Environmental factors such as lighting, reflections, and shadows may inconsistently obscure or highlight defects, further complicating screen assessment. Conventional techniques such as magnification, backlight tests, dead pixel tests, and pressure tests are often performed individually and manually, requiring significant amounts of time to holistically assess potential screen damage.

The present disclosure addresses these challenges by providing an automated, streamlined approach for assessing screen damage on a device. In some cases, a pattern may be displayed on a screen of a device, and a camera may capture one or more images of the pattern. The pattern may include various colors, gradients, and imagery to highlight specific issues on the screen. The captured images of the pattern may be analyzed to determine whether there are deviations from expected results corresponding to a screen without defects. These deviations may be compared to deviation thresholds to determine the presence and characteristics of defects on the screen.

In some cases, an indication of one or more defects may be communicated to a technician or other user. The defects may be visually indicated, and the visual indication may be selectable to view metadata associated with the defects. In some cases, a recommendation regarding a plan of action to address one or more defects may be communicated. Such a recommendation may grade devices for resale and reuse, providing guidance on whether to repair or replace a damaged screen, and whether to insure or resell the device with or without the identified screen damage.

The automated assessment approach described herein may remove human error from the assessment process by holistically assessing potential screen damage without the need for manual inspection. The approach may determine whether a mobile device has screen defects more quickly than the time required for technicians to run individual tests. In some cases, the mobile device may diagnose its own screen defects without requiring physical access by a technician, allowing remote assessment of device condition. The approach may employ a camera and a pattern to process analytics, determining the magnitude of one or more defects by employing thresholds and communicating informed indications and recommendations related to potential screen defects.

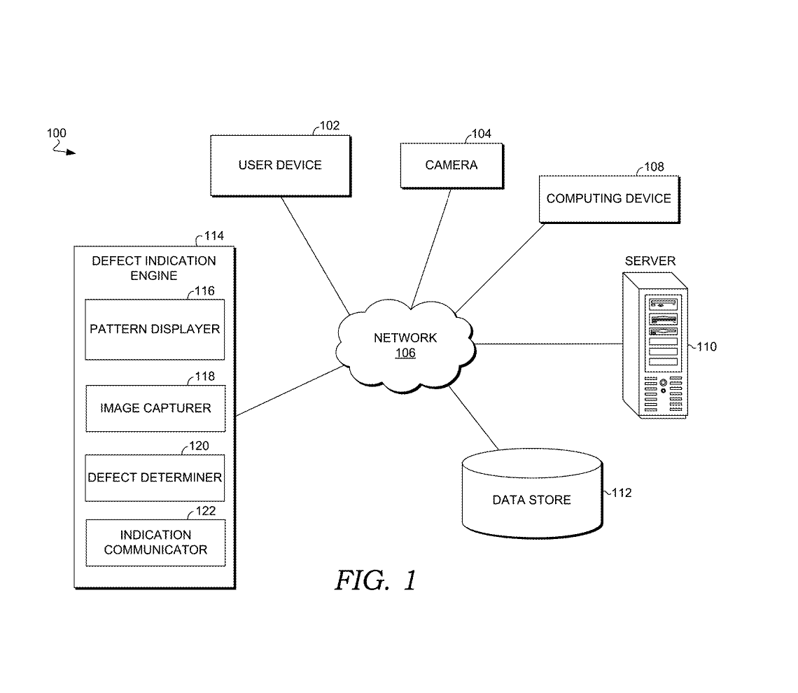

Referring to FIG. 1, an operating environment 100 in which aspects of the technology may be employed is illustrated. The operating environment 100 may include a user device 102, a camera 104, a network 106, a computing device 108, a server 110, a data store 112, and a defect indication engine 114. Each of the user device 102, the camera 104, the computing device 108, the server 110, and the data store 112 may communicate across the network 106 to the defect indication engine 114.

The network 106 may include one or more networks, such as a public network or a virtual private network. In some cases, the network 106 may include one or more local area networks, wide area networks, or other communication networks or methods. The network 106 may facilitate communication between the various components of the operating environment 100 to enable automated screen assessment.

The server 110 may be a computing device that implements functional aspects of the operating environment 100, such as one or more functions of the defect indication engine 114 to facilitate automated assessment of a screen on a device and determination of whether screen defects are present on the screen of the device. In some cases, the server 110 may be a processor. In some cases, the server 110 may be a smartphone receiving captured images of a pattern from the user device 102, the camera 104, or both. The server 110 may be wirelessly coupled to the user device 102, the camera 104, or both, and the server 110 may display a pattern on a screen of a device, capture the pattern, determine one or more defects on the screen, and communicate an indication of the one or more defects via a cellular or satellite network.

With continued reference to FIG. 1, the data store 112 may store information including data, computer instructions such as software program instructions, routines, or services, or models used in embodiments of the described technologies. In some cases, the data store 112 may store computer instructions for implementing functional aspects of the defect indication engine 114. Although depicted as a single data store component, the data store 112 may be embodied as one or more data stores or may be in a cloud computing environment.

The computing device 108 may be a client-side or front-end device. In addition to the server 110, the computing device 108 may implement functional aspects of the operating environment 100, such as one or more functions of the defect indication engine 114. In some cases, the computing device 108 may be used to assess a screen on the user device 102 and to determine that defects exist on the screen. Some implementations of the technology may comprise either a client-side or front-end computing device, a backend or server-side computing device, or both executing any combination of functions from the defect indication engine 114.

The user device 102 may be a personal device having a screen that can be assessed for screen defects. A screen defect may include a cracked screen, a scratched screen, a smudge, dead pixels, light bleeding, or screen burn. In some cases, the user device 102 may be a smartphone. The user device 102 may use short range communication protocols, such as Bluetooth, to pair or communicate with other devices for assessing a screen on the user device 102 and determining that screen defects exist on the screen of the user device 102, such as pairing or communicating with the camera 104, the server 110, or the computing device 108.

The camera 104 may be a camera that captures and transmits imagery. In some cases, the camera 104 may be a camera with a focal length of 35mm or shorter. In some cases, the camera 104 may be a camera of a cellular device, such as a smartphone. The imagery captured by the camera 104 may be a video comprising a plurality of frames, or the imagery may be one or more images. The camera 104 may capture a video or images of the user device 102. The camera 104 may be a front-screen camera located on a front of the user device 102 that captures the video or the one or more images by capturing a reflection of a pattern displayed on the user device 102, or the camera 104 may be an external camera not located on the user device 102 that captures the video or the one or more images by facing the user device 102 and capturing the pattern on the screen of the user device 102. In some cases, the user device 102 and the camera 104 may be paired using a short-range communication protocol, such as Bluetooth, such that the camera 104 can communicate captured images of the pattern to the defect indication engine 114.

The defect indication engine 114, either individually or in coordination with other components or systems, may assess a screen of the user device 102 and determine whether defects are present on the screen. In doing so, the defect indication engine 114 may display a pattern on the screen of the device, capture one or more images of the pattern on the screen, determine one or more defects on the screen based on the captured images, and communicate an indication of the one or more defects to a technician. Functions described with respect to the defect indication engine 114 may be performed by various devices, including the user device 102, the camera 104, the computing device 108, and the server 110, or combinations of these components.

The defect indication engine 114 may include a pattern displayer 116, an image capturer 118, a defect determiner 120, and an indication communicator 122. Each of these components may perform specific functions to facilitate automated assessment of a screen of the user device 102 and determination of whether defects are present on the screen.

The pattern displayer 116 may display a pattern on a screen of the user device 102. In some cases, the pattern displayer 116 may display the pattern on the screen of the user device 102 using a graphics processing unit (GPU). The pattern displayer 116 may display one or more patterns on the screen, where a first pattern may be used to confirm that the device that is about to be assessed is the device that is scheduled to be assessed, and a second pattern may be used to identify defects on the screen of the device. The first pattern may be an optical code, such as a two-dimensional or three-dimensional bar code. The second pattern may be displayed after determining that the screen of the device corresponds to the device subject to assessment. In some cases, the pattern may be rotated on the screen, and the camera 104 may capture one or more images of the pattern while in rotation.

The image capturer 118 may capture one or more images of the pattern on the screen using the camera 104. In some cases, the user device 102 and the camera 104 may be paired using a short-range communication protocol, such as Bluetooth, such that the camera 104 can communicate captured images of the pattern to the defect indication engine 114 via the image capturer 118. The image capturer 118 may utilize the camera 104 to capture images being displayed on the screen of the user device 102 when the screen is in an on-configuration, where the on-configuration indicates that the user device 102 or a display thereof is turned on.

The defect determiner 120 may determine that one or more defects are present on the screen based on the captured images of the pattern. In some cases, the defect determiner 120 may analyze the captured images to determine whether there are deviations in the pattern from expected results, indicating potential screen defects. The defect determiner 120 may compare the captured images of the pattern to normalized images of the same pattern corresponding to no defects on the screen of the user device 102. In some cases, the defect determiner 120 may compare the captured images of the pattern to normalized images corresponding to no defects on the screen of the user device 102 to determine if there are any deviations in the captured images from the normalized images. These deviations may be perturbations that are compared to a deviation threshold to determine the presence and characteristics of a defect on the screen of the user device 102.

The indication communicator 122 may communicate data associated with the defects to a technician. The indication communicator 122 may present a visual indication of the defects to a technician on a display, and the technician may select the visual indications to view metadata associated with the defects, such as a scratch pattern, reflectivity, contrast ratio, defect location, or depth of defect. In some cases, the indication communicator 122 may store the indication of one or more defects in the data store 112. The indication communicator 122 may communicate the indication of a defect for display at a remote display device. In some cases, the indication communicator 122 may generate a recommendation relating to how the defect should be addressed, and the indication communicator 122 may display the recommendation at a remote display device. The indication communicator 122 may generate a recommendation that grades any device analyzed by the defect indication engine 114 for resale or reuse.

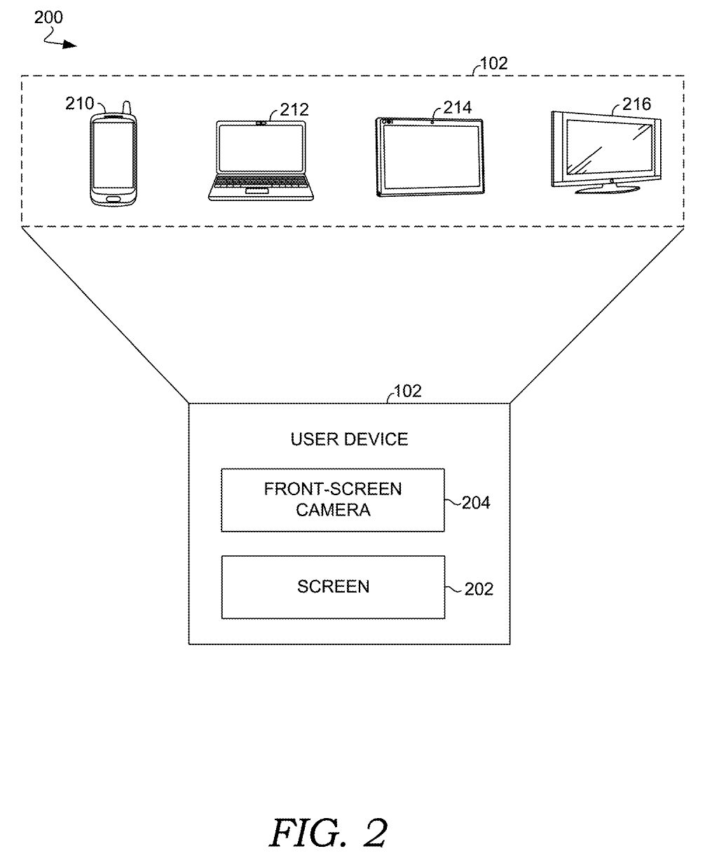

Referring to FIG. 2, a user device environment 200 in which aspects of the technology may be employed is illustrated. The user device environment 200 depicts various types of devices that may serve as the user device 102. These devices may include a smartphone 210, a computer 212, a tablet 214, and a television 216. Each of these devices represents an example of a personal device having a screen that can be assessed for screen defects using the described technology. In some cases, the user device 102 may be a smartwatch, an e-reader, or a gaming console in addition to smartphones, computers, tablets, and televisions. Any personal device with a screen may be used as the user device 102.

With continued reference to FIG. 2, the user device 102 may include a screen 202 and a front-screen camera 204. The screen 202 may be a liquid crystal display (LCD), an organic light-emitting diode (OLED) display, a mini-LED display, a MicroLED display, a quantum dot display (QLED), a retina display, a super retina display, or any other type of display suitable for a personal device. The screen 202 may occupy a front face of the user device 102 and may display patterns for defect assessment as described herein.

The front-screen camera 204 may be positioned on a front of the user device 102. In some cases, the front-screen camera 204 may be a camera with a focal length of 35mm or shorter. The front-screen camera 204 may be used to capture images of patterns displayed on the screen 202. In some cases, the front-screen camera 204 may capture images by capturing a reflection of a pattern displayed on the screen 202, enabling the user device 102 to assess the screen 202 for defects without requiring an external camera or physical inspection by a technician. The imagery captured by the front-screen camera 204 may be a video comprising a plurality of frames, or the imagery may be one or more images. The front-screen camera 204 may communicate captured images to the defect indication engine 114 for analysis and defect determination.

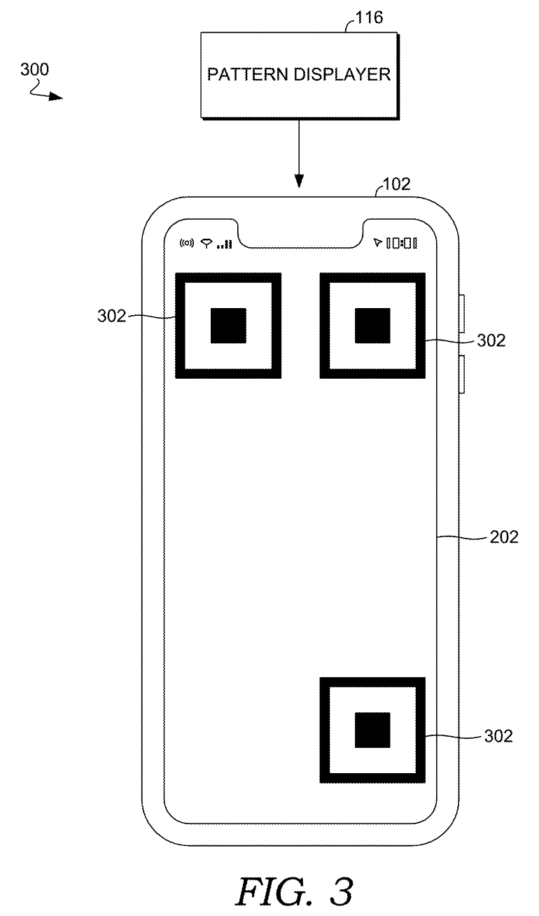

Referring to FIG. 3, an illustration 300 of the pattern displayer 116 displaying optical codes 302 on the screen 202 of the user device 102 is shown. In the illustration 300, the user device 102 is depicted as a smartphone with the screen 202 on which the pattern displayer 116 displays one or more optical codes 302. The optical codes 302 may include two-dimensional bar codes, three-dimensional bar codes, quick response (QR) codes, Aztec codes, or any other type of data transmission code.

In the illustration 300, three optical codes 302 are displayed on the screen 202, with two optical codes 302 positioned in an upper portion of the screen 202 and one optical code 302 positioned in a lower portion of the screen 202. The optical codes 302 may be displayed anywhere on the screen 202. In some cases, the pattern displayer 116 may place the optical codes 302 on corners of the screen 202 to identify the user device 102 as a subject device scheduled for assessment.

With continued reference to FIG. 3, the pattern displayer 116 may display the optical codes 302 on the screen 202, and a device such as the user device 102, the camera 104, or the computing device 108 may decode and retrieve data corresponding to the optical codes 302. The optical codes 302 may contain data identifying the device displaying the optical codes 302 as the device that is subject to be analyzed. In some cases, the camera 104 may capture one or more images of the optical codes 302 utilizing the image capturer 118, and the one or more images of the optical codes 302 captured by the camera 104 may be provided to the defect indication engine 114.

The defect indication engine 114 may read encoded data from the one or more optical codes 302 to verify that a display of the user device 102 corresponds to a display being accessed by the defect indication engine 114. In some cases, the defect indication engine 114 may determine that the camera 104 of the user device 102 is capturing the screen 202, and that the camera 104 and the screen 202 each correspond to the same mobile device using the optical codes 302.

In some cases, the defect indication engine 114 may compare the one or more images of the optical codes 302 to a plurality of optical codes that are associated with a plurality of devices and that are stored in the data store 112. The defect indication engine 114 may match the one or more images of the optical codes 302 with a set of optical codes corresponding to a subject device that is scheduled or intended to be assessed. The defect indication engine 114 may determine that the screen 202 of the user device 102 is associated with the subject device based on matching the one or more images of the optical codes 302 with the set of optical codes corresponding to the subject device. In some cases, after the user device 102 is determined to be the subject device, the pattern displayer 116 may display another pattern that is used to assess the screen 202 for screen defects.

The initial identification procedure using the optical codes 302 may help determine that each device being analyzed by the defect indication engine 114 is supposed to be analyzed by the defect indication engine 114. In some cases, the initial identification procedure may help prevent individuals from submitting images of a different device, such as a device in a flawless condition without any smudges, scratches, cracks, or dead pixels, in an attempt to circumvent the screen assessment process.

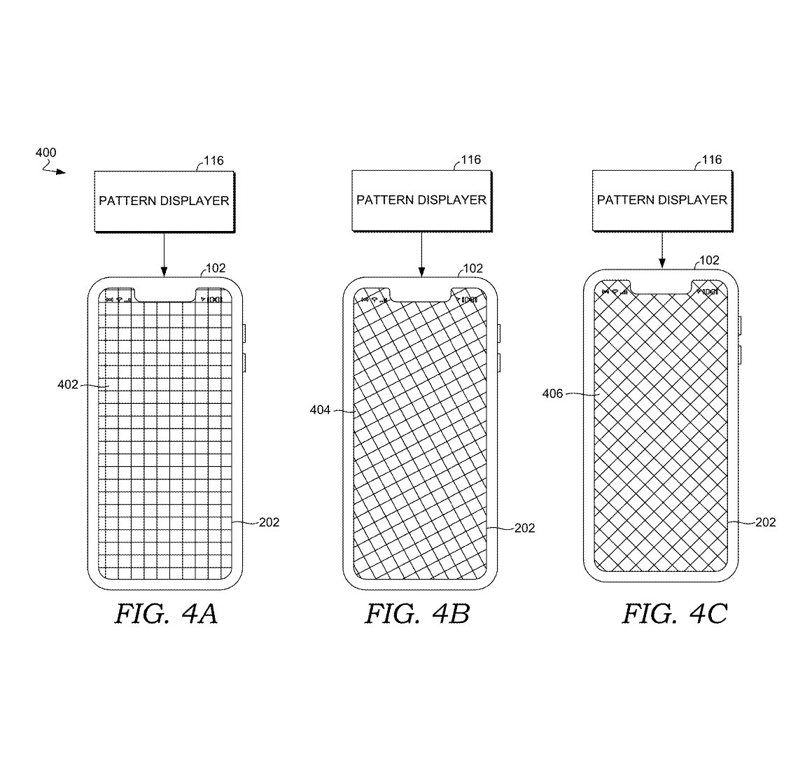

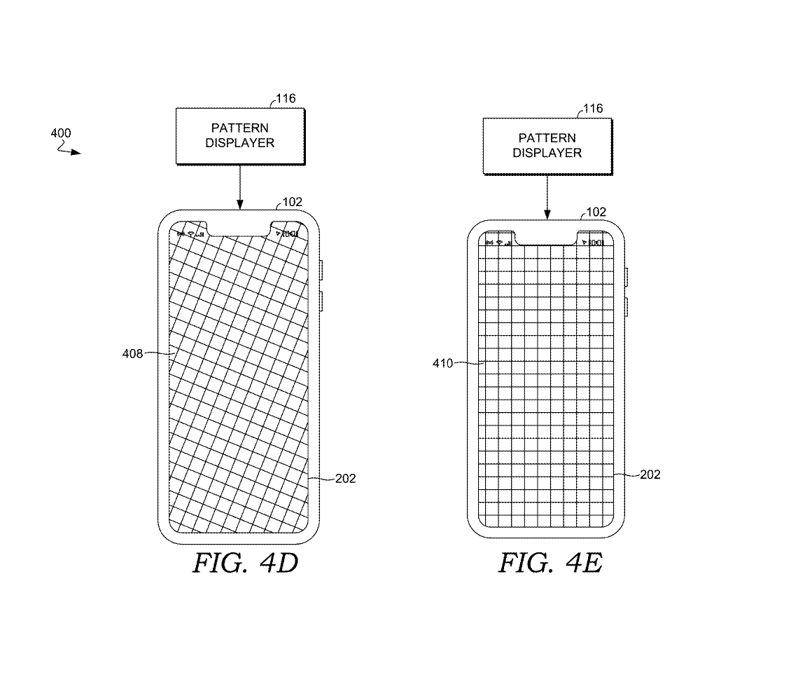

Referring to FIGS. 4A-4C, an illustration 400 of the pattern displayer 116 displaying patterns at multiple orientations on the screen 202 of the user device 102 is shown. In FIG. 4A, the pattern displayer 116 displays a first pattern orientation 402 on the screen 202 of the user device 102, where the first pattern orientation 402 comprises a grid of horizontal and vertical lines. In FIG. 4B, the pattern displayer 116 displays a second pattern orientation 404 on the screen 202 of the user device 102, where the second pattern orientation 404 shows the grid pattern rotated at an angle relative to the first pattern orientation 402, with the lines forming a diagonal crosshatch pattern. In FIG. 4C, the pattern displayer 116 displays a third pattern orientation 406 on the screen 202 of the user device 102, where the third pattern orientation 406 shows the grid pattern rotated further to form a denser diagonal crosshatch pattern.

With continued reference to FIGS. 4A-4C and referring to FIGS. 4D-4E, the illustration 400 depicts the pattern displayer 116 displaying additional pattern orientations on the screen 202 of the user device 102. In FIG. 4D, the screen 202 displays a fourth pattern orientation 408, which shows a grid pattern of intersecting lines oriented at a diagonal angle relative to the screen 202. In FIG. 4E, the screen 202 displays a fifth pattern orientation 410, which shows a grid pattern of intersecting horizontal and vertical lines forming a rectangular grid. The first pattern orientation 402, the second pattern orientation 404, the third pattern orientation 406, the fourth pattern orientation 408, and the fifth pattern orientation 410 represent the pattern as the pattern is rotated on the screen 202, which may be performed to help identify defects from different angles and ensure a comprehensive assessment of the screen 202.

In some cases, the pattern may rotate less than a full 360 degrees, rotate until one revolution is achieved, or rotate for several revolutions. In some cases, the pattern may be static on the screen 202 rather than rotating. The pattern may also be moved up or down along the screen 202, moved left or right along the screen 202, or moved diagonally along the screen 202. Whether the pattern is static or dynamic, the camera 104 may be used to capture one or more images of the pattern for defect analysis.

In some cases, a user holding the user device 102 may physically rotate or move the user device 102 while the pattern maintains a position as the pattern is displayed on the screen 202 of the user device 102. The user device 102 may display instructions for the user indicating a direction or speed of rotation. In some cases, the user device 102 may indicate at the screen 202 when a direction or speed of the user device 102, as determined by a gyroscope or accelerometer, matches the direction or speed indicated by the screen 202. The gyroscope or accelerometer may detect motion of the user device 102 and provide feedback to the user regarding whether the user device 102 is being rotated or moved in accordance with displayed instructions.

In some cases, the pattern may be normalized to establish a baseline before the pattern is rotated. The baseline may be a mathematical construct used to normalize the pattern, and the displayed pattern may be rotated about the baseline. In some cases, the displayed pattern is not rotated around the baseline, and the baseline serves as a reference for comparing captured images of the pattern to reference images corresponding to a screen without defects.

The pattern displayed on the screen for defect detection may take numerous forms to facilitate identification of various types of screen damage. In some cases, the pattern may comprise solid colors such as red, green, blue, white, and black, which may help identify issues such as dead pixels, stuck pixels, and color uniformity problems. Solid color patterns may provide a uniform background against which non-functional or malfunctioning pixels stand out, enabling detection of pixel-level defects across the screen surface.

In some cases, the pattern may comprise gradients, which are transition areas between colors. Gradient patterns may reveal issues with color banding, gradient uniformity, and subtle screen artifacts that may not be visible when using solid color patterns. The gradual transition between colors in a gradient pattern may expose irregularities in how the screen renders smooth color transitions, which may indicate underlying display defects or damage.

In some cases, the pattern may comprise checkerboard patterns, such as black and white squares or other alternating dark and light colors. Checkerboard patterns may highlight issues with pixel alignment, screen uniformity, and contrast. Checkerboard patterns may also identify physical defects such as superficial or non-superficial scratches or cracks on the screen, as such defects may cause visible distortions in the regular alternating pattern of squares.

In some cases, the pattern may comprise horizontal and vertical lines, such as a grid pattern. Horizontal and vertical line patterns may help detect alignment issues, screen tearing, and inconsistencies in pixel response. Line patterns may also identify superficial scratches or cracks, as such defects may cause visible deviations in the straightness or continuity of the displayed lines.

In some cases, the pattern may comprise text patterns displaying text in various fonts and sizes. Text patterns may help identify issues with text clarity, sharpness, and rendering. Text patterns may reveal defects that affect the legibility of displayed content, which may be relevant for assessing the functional impact of screen damage on typical device usage.

In some cases, the pattern may comprise geometric shapes such as circles, squares, triangles, or other polygons. Geometric shape patterns may reveal distortions, alignment issues, and geometric inaccuracies on the screen. Defects in the screen may cause visible warping or irregularities in the displayed geometric shapes, enabling identification of areas of the screen affected by damage.

In some cases, the pattern may comprise dynamic patterns such as animations. Dynamic patterns may help identify issues with refresh rates, motion blur, and screen responsiveness. Moving patterns may reveal defects that are not visible when the screen displays static content, such as intermittent pixel failures or response time variations across different areas of the screen.

In some cases, the pattern may comprise concentric circles or rings of varying radii. Concentric circle patterns may detect radial distortions caused by impact damage, as such damage may cause visible warping or irregularities in the circular patterns radiating outward from a center point. The varying radii of the concentric circles may enable detection of distortions at different distances from a point of impact.

In some cases, the pattern may include Moiré patterns. Moiré patterns may be particularly sensitive to detecting subtle screen irregularities and pixel misalignments. The interference patterns created by overlapping regular patterns in a Moiré configuration may amplify small deviations in pixel positioning or screen surface irregularities, making such defects more visible in captured images.

In some cases, the pattern may incorporate sinusoidal wave patterns with varying frequencies and amplitudes. Sinusoidal wave patterns may detect different scales of defects, as patterns with higher frequencies may reveal smaller defects while patterns with lower frequencies may reveal larger defects. The varying amplitudes of the sinusoidal waves may provide additional sensitivity to defects of different magnitudes.

In some cases, the pattern may include diagonal line patterns at multiple angles such as 30 degrees, 45 degrees, and 60 degrees. Diagonal line patterns at multiple angles may detect directional scratches that might be missed by purely horizontal or vertical patterns. Scratches on a screen surface may have a directional orientation, and diagonal line patterns oriented at various angles may intersect with such scratches at angles that make the scratches more visible in captured images.

In some cases, the pattern may include a combination of high-contrast edges and low-contrast gradients within the same display. Such a combination may simultaneously test for multiple defect types, as high-contrast edges may reveal defects that affect sharp transitions while low-contrast gradients may reveal defects that affect subtle color variations. The combination of high-contrast and low-contrast elements in a single pattern may enable comprehensive defect detection without requiring multiple separate patterns to be displayed sequentially.

In some cases, the pattern may comprise a series of progressively smaller geometric elements such as decreasing square sizes. Progressively smaller geometric elements may assess the resolution limits affected by screen damage, as defects may cause visible distortions in smaller elements while leaving larger elements unaffected. The series of decreasing sizes may enable determination of the scale at which screen damage begins to affect the visibility and clarity of displayed content.

The various pattern types described herein may be used individually or in combination, simultaneously or sequentially. In some cases, multiple pattern types may be displayed in sequence to provide comprehensive assessment of different types of screen defects. In some cases, multiple pattern types may be combined into a single composite pattern that enables detection of multiple defect types from a single captured image or set of images.

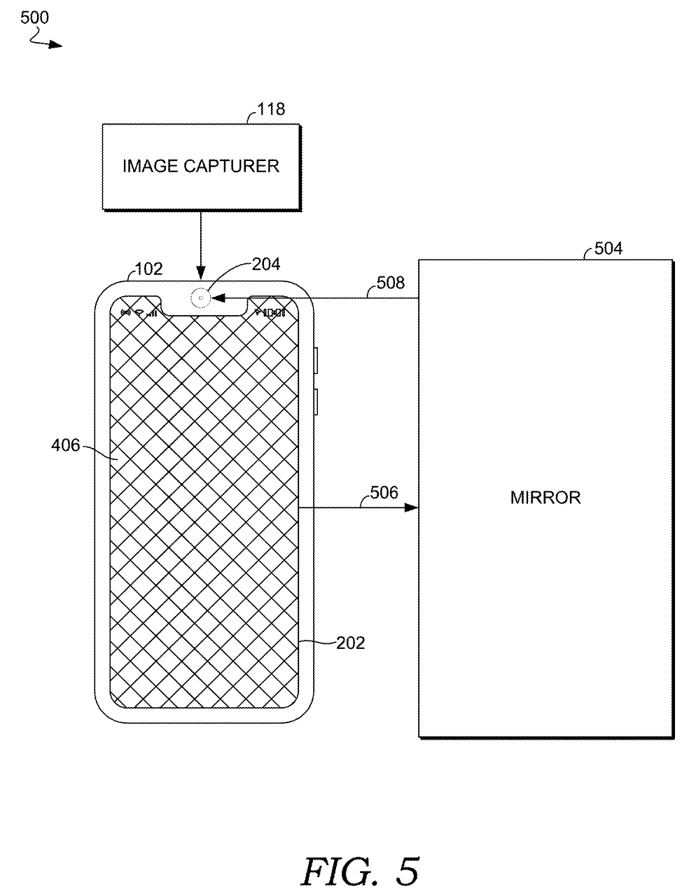

Referring to FIG. 5, an illustration 500 of the image capturer 118 capturing one or more images of the third pattern orientation 406 displayed on the screen 202 of the user device 102 using the front-screen camera 204 is shown. In the illustration 500, the user device 102 is positioned in front of a mirror 504 for capturing images of the third pattern orientation 406 displayed on the screen 202. The user device 102 includes the front-screen camera 204 located on a front aspect of the user device 102 and the screen 202 displaying the third pattern orientation 406, which is shown as a grid pattern comprising intersecting lines.

The mirror 504 is positioned adjacent to the user device 102 to reflect the third pattern orientation 406 displayed on the screen 202. An arrow 506 indicates a direction of the reflection of the third pattern orientation 406 from the screen 202 onto the mirror 504. An arrow 508 indicates a direction in which the front-screen camera 204 captures the reflection of the third pattern orientation 406 from the mirror 504. The image capturer 118 causes the front-screen camera 204 to capture one or more images of the third pattern orientation 406 by capturing the reflection of the third pattern orientation 406 on the mirror 504.

With continued reference to FIG. 5, the configuration depicted in the illustration 500 enables the user device 102 to capture images of the screen 202 using the front-screen camera 204 by positioning the user device 102 in front of the mirror 504. The one or more images of the third pattern orientation 406 captured by the front-screen camera 204 via the reflection on the mirror 504 may be provided to the defect indication engine 114 for analysis and defect determination. The captured images of the third pattern orientation 406 may be used by the defect indication engine 114 to determine whether there are any screen defects on the screen 202.

In some cases, the user device 102 may display instructions to present the screen 202 in an orientation such that the front aspect of the user device 102 is facing the mirror 504. The defect indication engine 114 may determine that the user device 102 is in the orientation using the image capturer 118 to capture an image of the reflection of the front aspect within the mirror 504. The defect indication engine 114 may determine that edges of the user device 102 are captured within the reflection. In some cases, the defect indication engine 114 may determine that one or more edges of the user device 102 are not captured in one or more images of the reflection, and responsive to the determination, the defect indication engine 114 may generate a display of instructions to reorient the user device 102. The instructions to reorient the user device 102 may guide a user to adjust the position or angle of the user device 102 relative to the mirror 504 such that all edges of the user device 102 are visible in the captured reflection, enabling comprehensive assessment of the screen 202 for defects.

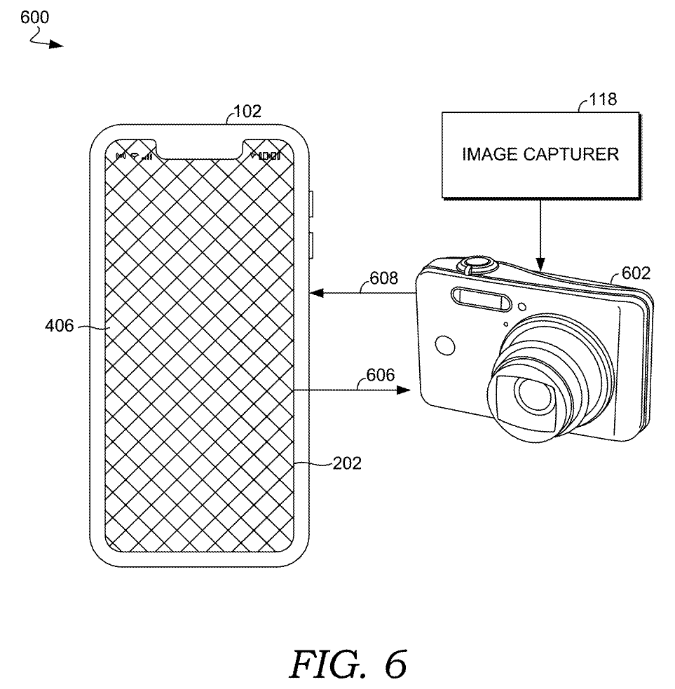

Referring to FIG. 6, an example illustration 600 of the image capturer 118 capturing one or more images of the third pattern orientation 406 displayed on the screen 202 of the user device 102 using an external camera 602 is shown. In the example illustration 600, the external camera 602 is located on a second user device separate from the user device 102. The external camera 602 may be used by the image capturer 118 to capture one or more images of the third pattern orientation 406 displayed on the screen 202 of the user device 102 from a distance separating the user device 102 from the external camera 602.

With continued reference to FIG. 6, the user device 102 is positioned in front of the external camera 602 such that the third pattern orientation 406 displayed on the screen 202 is capable of being captured by the external camera 602. An arrow 606 indicates a direction from the screen 202 of the user device 102 toward the external camera 602, depicting the orientation of the user device 102 relative to the external camera 602 for image capture. An arrow 608 indicates a direction in which the image capturer 118 captures one or more images of the third pattern orientation 406 using the external camera 602.

The external camera 602 may be aimed at the screen 202 to capture the third pattern orientation 406 displayed on the user device 102. The captured images of the third pattern orientation 406 may be used by the defect indication engine 114 to determine whether there are any screen defects on the screen 202. Whether using the front-screen camera 204 located on the user device 102 or the external camera 602 located on a separate device, the image capturer 118 of the defect indication engine 114 may capture one or more images of the pattern displayed on the screen 202 for defect analysis by the defect determiner 120.

The camera used to capture images of the displayed pattern may operate under various configurable parameters and may employ various techniques to enhance defect detection. In some cases, the camera may capture images at multiple exposure levels using bracketed exposure. Bracketed exposure involves capturing a series of images at different exposure settings, such as underexposed, properly exposed, and overexposed images. Bracketed exposure may detect defects that are visible under specific lighting conditions but not visible under other lighting conditions. For example, a hairline crack may be visible in an underexposed image due to light refraction characteristics that are not apparent in a properly exposed image. By capturing images at multiple exposure levels, the defect indication engine may analyze each exposure level to identify defects that might otherwise be missed when using a single exposure setting.

In some cases, the camera may employ high dynamic range (HDR) imaging techniques. HDR imaging techniques may capture both bright spots and dark areas of the screen simultaneously by combining multiple images taken at different exposure levels into a single composite image. HDR imaging may be useful for detecting defects such as light bleeding, where bright areas of the screen bleed into adjacent dark areas, or for detecting bright spots that may indicate backlight irregularities. The HDR imaging techniques may enable the defect indication engine to analyze a wider range of luminance values than would be possible with a single standard exposure image, thereby improving detection of defects that manifest as variations in brightness across the screen surface.

In some cases, multiple images may be captured at different focal distances to create a focus stack. A focus stack comprises a series of images where each image is focused at a different distance from the camera. The focus stack may reveal defects at various depths within the screen assembly. For example, a scratch on an outer protective layer of the screen may be in focus at a different focal distance than a defect within the display panel itself. By capturing images at different focal distances and analyzing the focus stack, the defect indication engine may determine the depth of a defect within the screen assembly, which may inform recommendations regarding whether the defect can be addressed by replacing a protective layer or whether the display panel itself requires replacement.

In some cases, the camera may capture images using different white balance settings. White balance settings affect how the camera interprets and renders colors in captured images. By capturing images using different white balance settings, the defect indication engine may enhance detection of color-related defects. For example, a defect that causes a subtle color shift in a portion of the screen may be more apparent when the image is captured using a white balance setting that emphasizes the affected color range. Different white balance settings may include settings calibrated for daylight, tungsten lighting, fluorescent lighting, or custom color temperature values. The analysis of images captured using different white balance settings may enable identification of color uniformity issues, color banding, or other color-related defects that might not be apparent when using a single white balance setting.

In some cases, time-lapse capture may be employed where multiple images are taken over a period of seconds. Time-lapse capture may detect intermittent defects such as flickering pixels. Intermittent defects may not be present in every captured image, but may appear sporadically over time. By capturing multiple images over a period of seconds and analyzing the sequence of images, the defect indication engine may identify pixels or areas of the screen that exhibit inconsistent behavior. For example, a pixel that flickers between an on state and an off state may appear as a dead pixel in some images and as a functional pixel in other images. The time-lapse capture technique may enable detection of such intermittent defects that would be missed by a single image capture.

In some cases, the camera may capture images at varying frame rates when recording video. Varying frame rates may detect refresh rate-related anomalies. The refresh rate of a screen determines how many times per second the screen updates the displayed image. When the frame rate of the camera does not align with the refresh rate of the screen, visual artifacts such as banding or flickering may appear in the captured video. By capturing video at varying frame rates, the defect indication engine may analyze the captured video to identify refresh rate-related anomalies that indicate screen defects. For example, a portion of the screen that exhibits different refresh rate behavior than the rest of the screen may indicate a defect in the display driver circuitry or the display panel. The analysis of video captured at varying frame rates may enable detection of defects that affect the temporal behavior of the screen rather than the static appearance of displayed content.

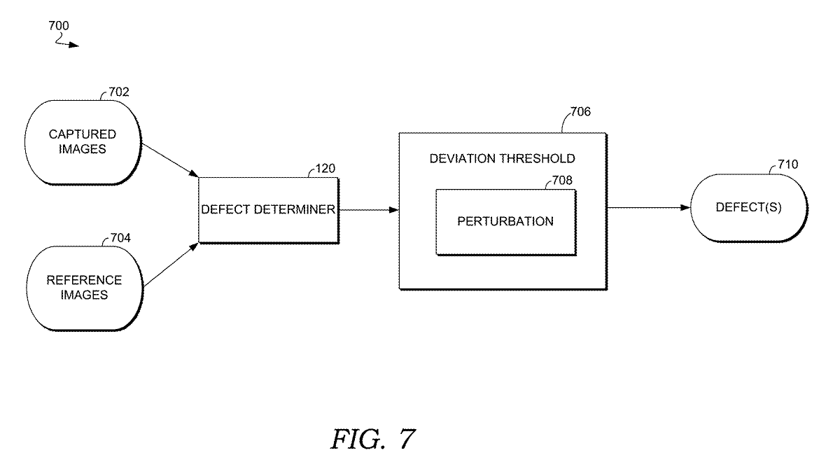

Referring to FIG. 7, an illustration 700 of the defect determiner 120 determining defects on the screen 202 is shown. In the illustration 700, the defect determiner 120 receives captured images 702 and reference images 704 as inputs. The captured images 702 represent images of a pattern displayed on the screen 202 of the user device 102 that have been captured by the camera 104, such as the front-screen camera 204 or the external camera 602. The reference images 704 represent images corresponding to the screen 202 without defects, providing a baseline for comparison. In some cases, the reference images 704 may be normalized images where pixel values of an image of the same pattern corresponding to no defects on the screen 202 have been adjusted so that the pixel values fall within a specific range, such as between 0 and 1, to normalize the image.

With continued reference to FIG. 7, the defect determiner 120 may compare the captured images 702 to the reference images 704 to identify deviations between the captured images 702 and the reference images 704. In some cases, the defect determiner 120 may compare the captured images 702 of the pattern to the reference images 704 frame by frame to determine if there are any perturbations. A perturbation 708 represents a deviation from at least one of the reference images 704, which may include distortions, changes in color, refractions of light, or other differences indicative of screen damage.

The output of the defect determiner 120 is provided to a deviation threshold 706 component. The deviation threshold 706 component evaluates whether the perturbation 708 in the captured images 702 meets or exceeds a predefined threshold. In some cases, the defect determiner 120 may apply a respective deviation threshold 706 to each of the detected perturbations 708, where each perturbation type corresponds to a specific deviation threshold 706. For example, a perturbation 708 indicative of a crack may correspond to a different deviation threshold 706 than a perturbation 708 indicative of a smudge or dead pixels.

When the perturbation 708 meets or exceeds the deviation threshold 706, the defect determiner 120 may determine that one or more defects 710 are present on the screen 202. The defects 710 output represents the identified screen defects, which may include cracks, scratches, smudges, dead pixels, light bleeding, bright spots, or screen burn. In some cases, the defect determiner 120 may determine the type of defect based on the type of perturbation 708, such as one or more cracks, smudges, scratches, light bleeding, bright spots, dead pixels, or screen burns.

In some cases, the defect determiner 120 may determine the extent of the defects 710 based on how much the deviation threshold 706 has been exceeded. For example, if the defect determiner 120 detects a perturbation 708 indicative of a crack in the screen 202, and the defect determiner 120 determines that the deviation threshold 706 is exceeded, the defect determiner 120 may determine the location and the depth or length of the crack on the screen 202 based on the magnitude by which the deviation threshold 706 has been exceeded. The illustration 700 demonstrates the flow of data from the captured images 702 and the reference images 704 through the defect determiner 120, the deviation threshold 706 evaluation including the perturbation 708 analysis, and ultimately to the determination of the defects 710.

The deviation threshold used to determine the presence of defects may be configured in multiple ways to accommodate different assessment scenarios and quality standards. In some cases, the deviation threshold may be dynamically adjusted based on a specific device model being assessed. Different device models may have different screen types with varying manufacturing tolerances, and the deviation threshold may account for known manufacturing tolerances of different screen types. For example, a first device model with a first screen type may have tighter manufacturing tolerances than a second device model with a second screen type, and the deviation threshold applied to the first device model may be different from the deviation threshold applied to the second device model to account for the different manufacturing tolerances. The dynamic adjustment of the deviation threshold based on device model may enable accurate defect detection across a range of device types without requiring manual reconfiguration of the assessment system for each device model.

In some cases, multiple tiered thresholds may be employed to distinguish between defects of different severity levels. A first threshold may indicate minor cosmetic defects, and progressively higher thresholds may indicate more severe functional defects. For example, a first tier threshold may correspond to minor scratches or smudges that do not affect device functionality, a second tier threshold may correspond to more visible scratches or small cracks that affect aesthetic appearance, and a third tier threshold may correspond to deep cracks or significant dead pixel clusters that affect device functionality. The tiered threshold approach may enable the defect indication engine to categorize detected defects by severity, which may inform recommendations regarding whether a device should be sold as-is, refurbished, or used for parts harvesting.

In some cases, the deviation threshold may be adjusted based on an intended end-use of the device being assessed. Devices intended for resale as like new may be assessed using stricter thresholds that detect even minor cosmetic imperfections, while devices intended for parts harvesting may be assessed using more lenient thresholds that focus on functional defects rather than cosmetic defects. The adjustment of the deviation threshold based on intended end-use may enable the assessment system to provide appropriate recommendations for different disposition pathways. For example, a device assessed for resale as like new may be flagged for minor scratches that would not be flagged for a device assessed for parts harvesting, as the minor scratches may affect resale value but may not affect the usability of harvested components.

In some cases, the deviation threshold may incorporate weighted factors where certain defect types are weighted more heavily than others. For example, dead pixels located in a center of the screen may be weighted more heavily than dead pixels located near edges of the screen, as dead pixels in the center of the screen may be more noticeable during typical device usage and may have a greater impact on user experience and resale value. Similarly, cracks that extend across a central viewing area of the screen may be weighted more heavily than cracks confined to peripheral areas of the screen. The weighted factors may be applied to the perturbation values detected in the captured images, such that a perturbation of a given magnitude in a heavily weighted area may exceed the deviation threshold while a perturbation of the same magnitude in a lightly weighted area may not exceed the deviation threshold. The incorporation of weighted factors may enable the assessment system to prioritize defects based on their impact on device usability and value.

In some cases, the deviation threshold may be user-configurable through an administrative interface. The administrative interface may allow different organizations to set their own quality standards by adjusting the deviation threshold values, the tiered threshold levels, the weighted factors, or other parameters that affect defect detection and classification. For example, a first organization with stringent quality requirements may configure the deviation threshold to detect minor cosmetic imperfections, while a second organization with less stringent quality requirements may configure the deviation threshold to detect functional defects while ignoring minor cosmetic imperfections. The user-configurable deviation threshold may enable the assessment system to be adapted to different business requirements and quality standards without requiring modification of the underlying defect detection algorithms. The administrative interface may provide controls for adjusting threshold values for different defect types, configuring weighted factors for different screen regions, and defining tiered threshold levels for defect severity classification.

In some cases, the defect determiner may employ artificial intelligence (AI) to determine whether defects are present on a screen of a device. The defect determiner may employ trained convolutional neural networks (CNNs) or other image processing models to analyze captured images of patterns displayed on the screen and identify defects. The CNNs or other image processing models may be trained on datasets comprising images of mobile device screens with various types of defects, such as dead pixels, color uniformity issues, cracks, scratches, smudges, light bleeding, bright spots, and screen burn. The training datasets for the AI model may include labeled examples of different defect types under various lighting conditions and of different display patterns. For example, the training datasets may include images of screens displaying solid color patterns, gradient patterns, checkerboard patterns, grid patterns, and other pattern types, where each image is labeled to indicate the presence, type, location, and severity of any defects visible in the image. The labeled examples may be captured under various lighting conditions, such as bright ambient lighting, dim ambient lighting, direct lighting, and diffuse lighting, to enable the trained model to accurately detect defects regardless of the lighting conditions present during assessment.

In some cases, the defect indication engine may utilize a multi-model ensemble approach where multiple neural networks independently analyze the captured images and their outputs are combined through voting or averaging. The multiple neural networks may include different architectures such as ResNet, VGG, and EfficientNet architectures. Each neural network architecture may have different strengths in detecting different types of defects or in analyzing different aspects of the captured images. For example, a first neural network architecture may be particularly effective at detecting fine scratches, while a second neural network architecture may be particularly effective at detecting dead pixel clusters. By combining the outputs of multiple neural networks through voting or averaging, the multi-model ensemble approach may achieve higher accuracy and robustness than any single neural network architecture alone. In a voting approach, each neural network may output a classification of whether a defect is present and the type of defect, and the final classification may be determined by majority vote among the neural networks. In an averaging approach, each neural network may output a probability or confidence score for each defect type, and the final probability or confidence score may be calculated as an average of the outputs from the multiple neural networks.

In some cases, the defect indication engine may employ a two-stage detection approach where a first model performs coarse defect localization and a second model performs fine-grained defect classification. In the two-stage detection approach, the first model may analyze the captured images to identify regions of the image that are likely to contain defects. The first model may output bounding boxes or region proposals indicating the locations of potential defects within the captured images. The second model may then analyze the identified regions to perform fine-grained defect classification, determining the specific type of defect present in each region and the severity of the defect. The two-stage detection approach may reduce computational requirements by focusing the fine-grained classification on regions of interest rather than analyzing the entire image at high resolution. The two-stage detection approach may also improve classification accuracy by allowing the second model to specialize in distinguishing between different defect types within localized regions.

In some cases, transfer learning may be applied using models pre-trained on general image recognition tasks and fine-tuned on screen defect datasets. Transfer learning involves using a neural network model that has been trained on a large dataset for a general task, such as image classification on a dataset of natural images, and adapting the model for a more specific task, such as screen defect detection. The pre-trained model may have learned general features useful for image analysis, such as edge detection, texture recognition, and shape recognition. By fine-tuning the pre-trained model on screen defect datasets, the model may adapt the general features to the specific task of detecting defects on mobile device screens. Transfer learning may reduce the amount of labeled training data required to achieve accurate defect detection, as the pre-trained model provides a starting point with useful learned features. Transfer learning may also reduce the computational resources and time required for training, as the fine-tuning process may converge more quickly than training a model from scratch.

In some cases, the defect indication engine may incorporate attention mechanisms that focus computational resources on regions of the image most likely to contain defects. Attention mechanisms enable a neural network to assign different weights to different regions of an input image, allowing the network to focus on regions that are most relevant for the task at hand. In the context of screen defect detection, attention mechanisms may enable the neural network to focus on regions of the captured image where defects are most likely to occur or where defects have been detected in preliminary analysis. For example, if a preliminary analysis indicates that a crack may be present in a particular region of the screen, the attention mechanism may assign higher weights to that region, causing the neural network to allocate more computational resources to analyzing that region in detail. Attention mechanisms may improve defect detection accuracy by enabling the neural network to focus on relevant regions while reducing the influence of irrelevant regions that do not contain defects.

In some cases, generative adversarial networks (GANs) may be used to augment training data by generating synthetic images of various defect types. A GAN comprises a generator network and a discriminator network that are trained together in an adversarial manner. The generator network generates synthetic images, and the discriminator network attempts to distinguish between real images and synthetic images. Through the adversarial training process, the generator network learns to generate synthetic images that are increasingly realistic and difficult for the discriminator network to distinguish from real images. In the context of screen defect detection, GANs may be trained to generate synthetic images of mobile device screens with various types of defects, such as cracks, scratches, smudges, and dead pixels. The synthetic images generated by the GANs may be used to augment the training dataset, providing additional labeled examples of defect types that may be rare or difficult to collect in real-world data. Data augmentation using GANs may improve the robustness and accuracy of the trained defect detection models by exposing the models to a wider variety of defect appearances during training.

In some cases, the defect indication engine may employ federated learning approaches where model improvements are derived from multiple assessment locations without centralizing sensitive device data. Federated learning is a machine learning approach where a model is trained across multiple decentralized devices or servers holding local data samples, without exchanging the data samples themselves. In the context of screen defect detection, federated learning may enable multiple assessment locations, such as different refurbishment facilities or retail locations, to contribute to improving the defect detection model without sharing the captured images of devices being assessed. Each assessment location may train a local model on the captured images collected at that location, and the local model updates may be aggregated to improve a global model that is distributed back to the assessment locations. Federated learning may address privacy concerns by keeping the captured images at the assessment locations where the images were collected, rather than transmitting the images to a central server. Federated learning may also enable the defect detection model to learn from a diverse range of device types and defect types encountered at different assessment locations, improving the generalization of the model across different assessment scenarios.

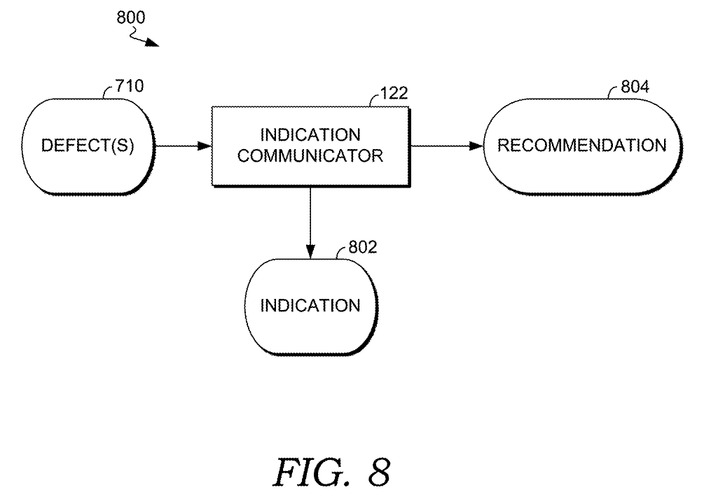

Referring to FIG. 8, an illustration 800 of the indication communicator 122 communicating an indication of defects is shown. In the illustration 800, the indication communicator 122 receives the defects 710 as an input. The defects 710 represent one or more screen defects that have been determined by the defect indication engine 114 based on analysis of the captured images 702 of a pattern displayed on the screen 202 of the user device 102.

With continued reference to FIG. 8, the indication communicator 122 processes the defects 710 and generates two outputs. A first output is an indication 802, which represents information about the defects 710 that may be communicated for display at the user device 102 or at a remote display device such as the computing device 108. The indication 802 may include details such as the type of defect, the extent of the defect, and the location of the defect on the screen 202. A second output is a recommendation 804, which represents a suggested course of action relating to how the defects 710 should be addressed.

In some cases, the indication communicator 122 may present a visual indication of the defects 710 to a technician on a display. The visual indication of the defects 710 may be selectable to view metadata associated with the defects 710. The metadata may include a scratch pattern, reflectivity, contrast ratio, defect location, and depth of defect. By selecting the visual indication, a technician may access detailed information about each detected defect to inform decisions regarding device disposition.

In some cases, the indication communicator 122 may store the indication 802 of one or more defects in the data store 112 for later access by a user such as a technician. Storing the indication 802 in the data store 112 may enable technicians to retrieve assessment results at a later time, compare assessment results across multiple devices, or generate reports summarizing defect findings across a batch of assessed devices.

The recommendation 804 may include instructions on various courses of action based on the defects 710. In some cases, the recommendation 804 may include instructions on whether to buff or clean the screen 202 to remove smudges. In some cases, the recommendation 804 may include instructions on whether to repair the screen 202. In some cases, the recommendation 804 may include instructions on whether to replace the screen 202. In some cases, the recommendation 804 may include instructions on whether to refurbish the user device 102.

In some cases, the recommendation 804 may include instructions to buff or clean the screen 202 and to sell the user device 102 on a wholesale market as used with an option for a buyer to purchase insurance. Such a recommendation 804 may be generated when the defects 710 are minor cosmetic defects such as smudges or superficial scratches that can be addressed through cleaning or buffing without requiring screen replacement.

In some cases, when the extent of the defects 710 is greater, the recommendation 804 may include instructions to replace the screen 202 and sell the user device 102 as refurbished without an option for a buyer to purchase insurance. Such a recommendation 804 may be generated when the defects 710 include deep cracks, significant dead pixel clusters, or other defects that require screen replacement to restore device functionality and aesthetic appearance.

In some cases, the indication communicator 122 may generate the recommendation 804 that instructs whether to insure a device for insurance purposes. The recommendation 804 may indicate whether the user device 102 is eligible for insurance coverage based on the type and severity of the defects 710 detected on the screen 202.

In some cases, the indication communicator 122 may provide a valuation of the user device 102 based on any defect that may be on the screen 202 of the user device 102. The valuation may reflect the impact of the detected defects 710 on the resale value of the user device 102, enabling informed decisions regarding pricing for resale or trade-in transactions.

The indication of defects determined by the defect indication engine may be communicated through various channels and formats to facilitate integration with different workflows and systems. In some cases, detailed PDF reports may be generated that include annotated images highlighting defect locations, defect classifications, and recommended remediation actions. The annotated images within the PDF reports may visually indicate the position of each detected defect on the screen, with annotations such as bounding boxes, arrows, or highlighted regions that draw attention to the specific areas where defects have been identified. The PDF reports may include textual descriptions of each defect classification, such as whether a defect is a crack, scratch, smudge, or dead pixel cluster, along with severity ratings and recommended actions for addressing each defect. The PDF reports may be stored for record-keeping purposes, transmitted to technicians or quality control personnel, or provided to customers as documentation of device condition assessments.

In some cases, real-time notifications may be sent via SMS, email, or push notifications to designated technicians or quality control personnel. Real-time notifications may enable immediate awareness of assessment results, allowing technicians to take prompt action on devices that require attention. SMS notifications may be sent to mobile phone numbers associated with designated personnel, providing brief summaries of assessment results that can be received even when personnel are away from computer workstations. Email notifications may provide more detailed assessment information, including links to full reports or access to assessment data through web-based interfaces. Push notifications may be sent to mobile applications installed on devices used by technicians or quality control personnel, enabling immediate alerts that appear on device screens without requiring personnel to actively check for new messages. The real-time notification mechanisms may be configured to send notifications based on specific criteria, such as sending notifications when defects of a particular severity level are detected or when assessment results require immediate review.

In some cases, integration with enterprise resource planning (ERP) systems may be provided to automatically update inventory records with device condition assessments. ERP systems are software platforms used by organizations to manage business processes, including inventory management, order processing, and financial tracking. By integrating with ERP systems, the defect indication engine may automatically transmit assessment results to the ERP system, which may then update inventory records to reflect the condition of assessed devices. For example, when a device is assessed and defects are detected, the ERP system may update the inventory record for that device to indicate the type and severity of defects, the recommended disposition pathway, and the estimated value of the device based on the assessment results. The integration with ERP systems may reduce manual data entry, improve accuracy of inventory records, and enable automated workflows that route devices to appropriate disposition pathways based on assessment results.

In some cases, API endpoints may be provided to allow third-party systems to query defect assessment results programmatically. API endpoints are interfaces that enable software applications to communicate with each other by sending requests and receiving responses in standardized formats. By providing API endpoints, the defect indication engine may enable third-party systems, such as customer relationship management systems, e-commerce platforms, or custom business applications, to retrieve assessment results for specific devices, query assessment history, or initiate new assessments. The API endpoints may support various query parameters, such as device identifiers, date ranges, defect types, or severity levels, enabling third-party systems to retrieve assessment data that meets specific criteria. The API endpoints may implement authentication and authorization mechanisms to control access to assessment data and to ensure that assessment results are accessible to authorized systems and users.

In some cases, machine-readable output formats such as JSON or XML may be generated for integration with automated processing workflows. JSON (JavaScript Object Notation) and XML (Extensible Markup Language) are data interchange formats that enable structured data to be transmitted between systems and processed by software applications. By generating assessment results in JSON or XML formats, the defect indication engine may enable automated processing workflows to consume assessment data without requiring manual interpretation or data transformation. For example, an automated processing workflow may receive assessment results in JSON format, parse the JSON data to extract defect classifications and severity ratings, and automatically route devices to appropriate processing stations based on the extracted data. The machine-readable output formats may include structured representations of defect locations, defect types, severity ratings, recommended actions, and other assessment data, enabling automated systems to make decisions and take actions based on assessment results.

In some cases, voice-based reporting may be provided through integration with voice assistants, allowing hands-free operation in warehouse environments. Voice assistants are software applications that respond to voice commands and provide spoken responses, enabling users to interact with systems without using hands or viewing displays. By integrating with voice assistants, the defect indication engine may enable technicians to receive assessment results through spoken announcements, query assessment status using voice commands, or initiate assessments through voice instructions. Voice-based reporting may be particularly useful in warehouse environments where technicians may be handling devices or performing other tasks that occupy their hands, making it inconvenient to interact with displays or input devices. For example, a technician may speak a voice command to request the assessment status of a specific device, and the voice assistant may respond with a spoken summary of the detected defects and recommended actions. Voice-based reporting may improve efficiency in high-throughput assessment environments by enabling technicians to receive information and issue commands without interrupting their physical tasks.

The defect indication engine may incorporate mechanisms to compensate for varying environmental conditions during assessment. Environmental conditions such as ambient lighting, temperature, and humidity may affect the appearance of captured images and the behavior of the screen being assessed. By compensating for environmental conditions, the defect indication engine may maintain consistent detection accuracy across different assessment environments and may avoid misclassifying environmental artifacts as permanent screen defects.

In some cases, ambient light sensors may be used to adjust pattern brightness and contrast to maintain consistent detection accuracy across different lighting environments. Ambient light sensors are sensors that measure the intensity of light in the surrounding environment. The ambient light sensors may be positioned to measure the ambient light level in the vicinity of the screen being assessed. Based on the measured ambient light level, the defect indication engine may adjust the brightness and contrast of the pattern displayed on the screen. For example, in a brightly lit environment, the defect indication engine may increase the brightness of the displayed pattern to ensure that the pattern is clearly visible in captured images despite the high ambient light level. In a dimly lit environment, the defect indication engine may decrease the brightness of the displayed pattern to avoid overexposure in captured images. By adjusting pattern brightness and contrast based on ambient light measurements, the defect indication engine may ensure that captured images have consistent characteristics regardless of the lighting environment in which the assessment is performed, enabling accurate defect detection across different assessment locations and times of day.

In some cases, the defect indication engine may detect and compensate for reflections from overhead lighting by analyzing multiple captured images and filtering out consistent reflection artifacts. Overhead lighting, such as fluorescent lights, incandescent lights, or natural light from windows, may cause reflections on the screen surface that appear in captured images. These reflections may obscure portions of the displayed pattern or may be misinterpreted as screen defects if not properly identified and compensated. The defect indication engine may capture multiple images of the displayed pattern, where each image may be captured at a slightly different time or with the pattern at a slightly different position on the screen. By analyzing the multiple captured images, the defect indication engine may identify reflection artifacts that appear consistently across the multiple images at the same position relative to the screen. Consistent reflection artifacts may be distinguished from screen defects because screen defects move with the pattern when the pattern is repositioned on the screen, while reflection artifacts remain at fixed positions on the screen surface regardless of pattern position. The defect indication engine may filter out the identified consistent reflection artifacts from the analysis, preventing the reflection artifacts from being classified as screen defects.

In some cases, temperature sensors may be incorporated to account for screen behavior variations at different operating temperatures. Temperature sensors are sensors that measure the temperature of the screen or the ambient temperature in the assessment environment. Screen behavior may vary at different operating temperatures due to the physical properties of display components. For example, liquid crystal displays may exhibit slower response times at lower temperatures, which may affect the appearance of displayed patterns in captured images. Organic light-emitting diode displays may exhibit variations in brightness or color at different temperatures. By incorporating temperature sensors, the defect indication engine may measure the temperature at which the assessment is being performed and may adjust the analysis parameters or reference images to account for expected screen behavior variations at the measured temperature. For example, if the temperature sensor indicates that the screen is operating at a low temperature, the defect indication engine may apply adjusted deviation thresholds that account for the expected slower response times of the display at low temperatures, preventing normal temperature-related behavior from being misclassified as a screen defect.

In some cases, the defect indication engine may include calibration routines that use a known reference surface to establish baseline conditions before each assessment session. A known reference surface is a surface with known characteristics, such as a screen without defects or a calibration target with known patterns and colors. Before beginning an assessment session, the defect indication engine may perform a calibration routine in which the camera captures images of the known reference surface under the current environmental conditions. The captured images of the known reference surface may be analyzed to establish baseline conditions, such as the expected appearance of colors, the expected brightness levels, and the expected contrast ratios under the current lighting and temperature conditions. The established baseline conditions may then be used as a reference for analyzing captured images of screens being assessed during the assessment session. By establishing baseline conditions before each assessment session, the defect indication engine may account for variations in environmental conditions between assessment sessions and may ensure that defect detection is calibrated to the specific conditions present during each session.

In some cases, humidity sensors may be employed to detect conditions that could cause temporary condensation-related artifacts that should not be classified as permanent defects. Humidity sensors are sensors that measure the moisture content of the air in the assessment environment. High humidity levels may cause condensation to form on the screen surface, particularly when a device is moved from a cold environment to a warm environment or when the ambient humidity is high. Condensation on the screen surface may appear in captured images as smudges, haze, or other artifacts that may resemble certain types of screen defects. By employing humidity sensors, the defect indication engine may detect when humidity levels are high enough to potentially cause condensation-related artifacts. When high humidity conditions are detected, the defect indication engine may flag the assessment results to indicate that condensation-related artifacts may be present, may delay the assessment until the screen has acclimated to the environment and any condensation has dissipated, or may apply analysis techniques that distinguish between temporary condensation-related artifacts and permanent screen defects. The humidity sensors may enable the defect indication engine to avoid misclassifying temporary condensation-related artifacts as permanent defects, improving the accuracy of defect detection in environments with varying humidity levels.

The assessment process may accommodate various device orientations and positioning methods to optimize defect visibility and ensure comprehensive assessment of the screen surface. Different orientations and positions of the device relative to the camera may reveal different types of defects or may make certain defects more visible due to variations in lighting angles, reflection characteristics, and viewing perspectives.

In some cases, the defect indication engine may instruct users to position the device at specific angles relative to the camera or mirror to optimize defect visibility. The defect indication engine may display instructions on the screen of the device being assessed or on a separate display device, guiding the user to orient the device at a particular angle. For example, the instructions may direct the user to tilt the device at a 30-degree angle relative to the camera to enhance visibility of scratches that run in a particular direction, or to position the device perpendicular to the camera to optimize detection of dead pixels. The specific angles indicated by the instructions may be determined based on the type of defect being assessed, the characteristics of the pattern being displayed, or the lighting conditions in the assessment environment. By instructing users to position the device at specific angles, the defect indication engine may ensure that captured images are taken from orientations that maximize the visibility of potential defects, improving the accuracy and completeness of the assessment.

In some cases, a motorized fixture may be employed to automatically rotate the device through multiple orientations during assessment. The motorized fixture may be a mechanical apparatus that holds the device and rotates the device about one or more axes under automated control. The motorized fixture may rotate the device through a predetermined sequence of orientations, pausing at each orientation to allow the camera to capture one or more images of the displayed pattern. For example, the motorized fixture may rotate the device through 360 degrees about a vertical axis, capturing images at intervals such as every 15 degrees or every 30 degrees. The motorized fixture may also tilt the device about a horizontal axis to capture images at different tilt angles. By employing a motorized fixture to automatically rotate the device, the defect indication engine may ensure consistent and repeatable positioning across multiple assessments, eliminating variability that may arise from manual positioning by users. The automated rotation provided by the motorized fixture may also enable high-throughput assessment workflows where devices are loaded into the fixture and assessed without requiring manual intervention during the image capture process.

In some cases, the defect indication engine may utilize accelerometer and gyroscope data from the device being assessed to track the orientation of the device and correlate defect visibility with specific viewing angles. Accelerometers are sensors that measure acceleration forces, which may be used to determine the orientation of the device relative to gravity. Gyroscopes are sensors that measure angular velocity, which may be used to track rotational movement of the device. Many mobile devices include accelerometers and gyroscopes as standard components. The defect indication engine may access data from the accelerometer and gyroscope of the device being assessed to determine the current orientation of the device in three-dimensional space. As the device is rotated or tilted, the accelerometer and gyroscope data may be recorded along with the captured images, enabling the defect indication engine to correlate the visibility of detected defects with the specific viewing angles at which the images were captured. For example, if a particular defect is visible in images captured when the device is tilted at a 45-degree angle but not visible in images captured when the device is held perpendicular to the camera, the defect indication engine may record this correlation and may use the information to characterize the defect or to inform recommendations regarding the defect. The utilization of accelerometer and gyroscope data may enable the defect indication engine to track device orientation without requiring external positioning equipment, allowing users to manually rotate the device while the defect indication engine automatically records the orientation at which each image is captured.

In some cases, multiple cameras positioned at different angles may simultaneously capture images to provide comprehensive coverage without requiring device movement. The multiple cameras may be arranged in a fixed configuration around a position where the device is placed for assessment. For example, a first camera may be positioned directly in front of the device to capture images from a perpendicular viewing angle, a second camera may be positioned above and to the left of the device to capture images from an elevated left-side viewing angle, and a third camera may be positioned above and to the right of the device to capture images from an elevated right-side viewing angle. Additional cameras may be positioned at other angles to provide further coverage. By capturing images simultaneously from multiple cameras at different angles, the defect indication engine may obtain a comprehensive set of images that reveal defects from various viewing perspectives without requiring the device to be moved or rotated during the image capture process. The simultaneous capture from multiple cameras may reduce the time required for assessment, as all images may be captured in a single capture event rather than requiring sequential captures at different device orientations. The multiple camera configuration may also ensure consistent positioning of the device relative to each camera, as the device remains stationary while images are captured from the multiple viewing angles.

In some cases, the defect indication engine may employ a turntable mechanism that rotates the device while maintaining a fixed camera position. The turntable mechanism may be a rotating platform on which the device is placed for assessment. The turntable mechanism may rotate the device about a vertical axis while the camera remains in a fixed position relative to the turntable. As the turntable rotates, the camera may capture images of the displayed pattern at different rotational positions of the device. For example, the turntable may rotate the device through 360 degrees, and the camera may capture images at regular intervals during the rotation, such as every 10 degrees or every 20 degrees. The turntable mechanism may provide controlled and repeatable rotation of the device, ensuring that images are captured at consistent rotational positions across multiple assessments. The fixed camera position may simplify the image capture configuration, as the camera does not need to be moved or repositioned during the assessment. The turntable mechanism may be motorized to provide automated rotation, or the turntable mechanism may be manually rotated by a user while the defect indication engine tracks the rotational position and triggers image capture at appropriate intervals.

The defect indication engine may provide quantified metrics for defect severity beyond binary presence or absence determination. Quantified metrics may enable more precise characterization of screen condition and may inform more accurate valuations and disposition recommendations. Various types of defects may be quantified using different measurement approaches appropriate to the characteristics of each defect type.

In some cases, crack length and branching complexity may be measured in millimeters and reported as numerical values. The defect indication engine may analyze captured images to trace the path of a detected crack across the screen surface. The length of the crack may be calculated by measuring the distance along the crack path from one end of the crack to the other end of the crack. For cracks that branch into multiple paths, the defect indication engine may measure the length of each branch and may calculate a total crack length as the sum of the lengths of all branches. Branching complexity may be quantified by counting the number of branch points where a single crack path divides into multiple paths, or by calculating a branching ratio that represents the relationship between the total length of all branches and the length of the main crack path. The crack length and branching complexity measurements may be reported as numerical values in millimeters, enabling comparison of crack severity across different devices and enabling tracking of crack progression over time if a device is assessed multiple times.

In some cases, dead pixel clusters may be quantified by total affected area as a percentage of screen surface. The defect indication engine may identify individual dead pixels or groups of adjacent dead pixels that form clusters. For each identified dead pixel or dead pixel cluster, the defect indication engine may calculate the area of the screen surface affected by the dead pixels. The total affected area may be calculated as the sum of the areas of all identified dead pixels and dead pixel clusters. The total affected area may then be expressed as a percentage of the total screen surface area. For example, if a screen has a total surface area of 10,000 square millimeters and the total affected area of dead pixel clusters is 50 square millimeters, the dead pixel cluster quantification may be reported as 0.5 percent of the screen surface. Expressing dead pixel cluster severity as a percentage of screen surface may enable comparison across devices with different screen sizes, as a dead pixel cluster of a given absolute size may represent a more significant defect on a smaller screen than on a larger screen.

In some cases, scratch depth may be estimated based on light refraction characteristics and reported on a standardized scale. Scratches on a screen surface may cause light to refract differently than the surrounding undamaged surface. Deeper scratches may cause more pronounced refraction effects than shallower scratches. The defect indication engine may analyze the light refraction characteristics of detected scratches in captured images to estimate the depth of each scratch. The analysis may examine factors such as the intensity of light refraction, the width of the refracted light pattern, and the contrast between the scratch and the surrounding surface. Based on the light refraction characteristics, the defect indication engine may assign a depth estimate to each scratch. The depth estimate may be reported on a standardized scale, such as a numerical scale from 1 to 10 where 1 represents a superficial scratch that affects the outermost surface layer and 10 represents a deep scratch that penetrates through multiple layers of the screen assembly. The standardized scale may enable consistent communication of scratch severity across different assessments and may inform recommendations regarding whether a scratch can be addressed through buffing or polishing versus whether the scratch requires screen replacement.

In some cases, screen burn severity may be quantified based on the contrast differential between affected and unaffected areas. Screen burn, also referred to as image retention or burn-in, occurs when a static image displayed on a screen for an extended period causes permanent discoloration or ghosting in the affected area. The defect indication engine may detect screen burn by analyzing captured images of patterns displayed on the screen and identifying areas where the displayed pattern appears differently than expected due to underlying screen burn. The severity of screen burn may be quantified by measuring the contrast differential between the affected area and adjacent unaffected areas. The contrast differential may be calculated by comparing the brightness, color values, or other visual characteristics of the affected area to the corresponding characteristics of the unaffected areas. A higher contrast differential may indicate more severe screen burn that is more visible during normal device usage. The contrast differential may be reported as a numerical value or as a percentage, enabling comparison of screen burn severity across different devices and different affected areas within the same device.

In some cases, an overall screen condition score may be calculated as a weighted combination of individual defect metrics, providing a single numerical grade for the device. The overall screen condition score may aggregate the quantified metrics for different defect types into a single value that represents the overall condition of the screen. The calculation of the overall screen condition score may apply weights to each individual defect metric to reflect the relative impact of each defect type on device usability and value. For example, a weight applied to crack length may be higher than a weight applied to minor scratch depth, reflecting that cracks may have a greater impact on device functionality and resale value than minor scratches. The weights may be configurable to accommodate different quality standards or different intended uses for assessed devices. The overall screen condition score may be calculated by multiplying each individual defect metric by the corresponding weight and summing the weighted values. The resulting overall screen condition score may be expressed on a standardized scale, such as a scale from 0 to 100 where 100 represents a screen in flawless condition with no detected defects and lower scores represent screens with progressively more severe defects. The overall screen condition score may provide a convenient summary of screen condition that enables rapid comparison across devices and may be used to sort or filter devices based on condition in inventory management systems.

The defect indication engine may be configured to assess multiple devices in batch processing modes to accommodate high-throughput assessment workflows. Batch processing modes may enable assessment of large numbers of devices in commercial refurbishment operations, retail trade-in programs, or other scenarios where many devices require assessment within a limited time period.

In some cases, a conveyor-based system may transport devices past a fixed camera station for high-throughput assessment. The conveyor-based system may include a conveyor belt or other transport mechanism that moves devices along a predetermined path through an assessment area. The fixed camera station may be positioned along the conveyor path at a location where devices pass within the field of view of one or more cameras. As each device is transported past the fixed camera station, the conveyor-based system may pause the conveyor or synchronize image capture with the movement of the conveyor to capture images of patterns displayed on the screen of each device. The conveyor-based system may include mechanisms to position devices in a consistent orientation on the conveyor, such as guides, fixtures, or alignment features that ensure each device is presented to the fixed camera station at a consistent angle and distance. The conveyor-based system may enable continuous or semi-continuous assessment of devices, where devices are loaded onto the conveyor at one end, transported through the assessment area, and unloaded at the other end after assessment is complete. The conveyor-based system may be integrated with sorting mechanisms that route assessed devices to different destinations based on assessment results, such as routing devices with no detected defects to a first destination and routing devices with detected defects to a second destination for further inspection or remediation.

In some cases, multiple devices may be arranged in a grid pattern and assessed simultaneously using a single high-resolution camera. The grid pattern arrangement may position devices in rows and columns on a flat surface within the field of view of the high-resolution camera. Each device in the grid pattern may display a pattern on the screen of the device, and the high-resolution camera may capture a single image or a series of images that includes all devices in the grid pattern. The defect indication engine may analyze the captured image to identify the individual devices within the grid pattern and to extract the portion of the image corresponding to each device for individual defect analysis. The high-resolution camera may have sufficient resolution to capture detailed images of each device in the grid pattern, enabling accurate defect detection for each device despite the multiple devices being captured in a single image. The grid pattern arrangement may reduce the time required to assess multiple devices by enabling simultaneous image capture for all devices in the grid rather than requiring sequential image capture for each device individually. The number of devices that may be arranged in the grid pattern may depend on the resolution of the high-resolution camera, the size of the devices being assessed, and the level of detail required for accurate defect detection.

In some cases, the defect indication engine may maintain a queue of devices awaiting assessment and automatically process the devices in sequence. The queue may be a data structure that stores identifiers or references to devices that have been submitted for assessment but have not yet been processed. Devices may be added to the queue as the devices are received for assessment, and the defect indication engine may retrieve devices from the queue in order and perform assessment on each device in sequence. The queue may operate on a first-in-first-out basis, where devices are processed in the order in which the devices were added to the queue, or the queue may support priority ordering where certain devices are processed before other devices based on priority criteria. The defect indication engine may automatically initiate assessment of the next device in the queue when assessment of the current device is complete, enabling continuous processing without requiring manual intervention to start each assessment. The queue may be displayed on a user interface to show the status of devices awaiting assessment, devices currently being assessed, and devices for which assessment has been completed. The queue-based processing may enable efficient utilization of assessment resources by ensuring that assessment stations are continuously occupied with devices to assess rather than sitting idle between assessments.

In some cases, parallel processing may be employed where multiple assessment stations operate simultaneously and report results to a centralized database. Each assessment station may include a camera, a display or fixture for positioning devices, and processing hardware or software for performing defect analysis. The multiple assessment stations may operate independently, with each assessment station capable of assessing devices without coordination with other assessment stations. As each assessment station completes assessment of a device, the assessment station may transmit the assessment results to the centralized database. The centralized database may store assessment results from all assessment stations, enabling aggregation of results across the multiple stations and providing a unified view of assessment activity and outcomes. The parallel processing configuration may increase the total throughput of the assessment system by enabling multiple devices to be assessed concurrently at different assessment stations. The centralized database may support queries and reports that span assessment results from all assessment stations, enabling analysis of defect trends, assessment volumes, and other metrics across the entire assessment operation. The parallel processing configuration may be scaled by adding additional assessment stations to increase throughput as assessment volumes increase.

In some cases, the defect indication engine may support barcode or RFID scanning to automatically associate assessment results with specific device serial numbers in batch operations. Barcode scanning may involve reading a barcode label affixed to a device or displayed on the screen of the device, where the barcode encodes a serial number or other identifier for the device. RFID scanning may involve reading an RFID tag embedded in or attached to a device, where the RFID tag stores a serial number or other identifier for the device. The defect indication engine may include a barcode scanner, an RFID reader, or both to read device identifiers during the assessment process. When a device is presented for assessment, the barcode or RFID scanner may read the device identifier, and the defect indication engine may associate the assessment results for that device with the read identifier. The association between assessment results and device identifiers may be stored in a database, enabling retrieval of assessment results for a specific device by querying the database using the device identifier. The barcode or RFID scanning may be performed automatically as part of the assessment workflow, such as by scanning the device identifier before or after image capture, or the scanning may be performed manually by an operator using a handheld scanner. The automatic association of assessment results with device serial numbers may reduce errors that could arise from manual data entry and may enable tracking of individual devices through assessment and subsequent processing steps.

The defect indication engine may incorporate historical data analysis capabilities to enable identification of trends and patterns in assessment results over time. Assessment results generated by the defect indication engine may be stored in a database and analyzed over time to identify trends in defect types across device models or manufacturing batches. The database may accumulate assessment results from multiple devices assessed over an extended period, such as days, weeks, months, or years. The accumulated assessment results may include information about the types of defects detected on each device, the severity of each defect, the device model, the manufacturing batch or serial number range, the date of assessment, and other relevant data. By analyzing the accumulated assessment results, the defect indication engine may identify patterns in defect occurrence that may not be apparent from individual assessments. For example, the analysis may reveal that a particular device model exhibits a higher rate of a specific defect type than other device models, or that devices from a particular manufacturing batch exhibit a higher overall defect rate than devices from other manufacturing batches. The identification of trends in defect types across device models or manufacturing batches may inform quality control decisions, such as adjusting inspection procedures for device models with known defect tendencies or initiating investigations into manufacturing processes that may be contributing to elevated defect rates in specific batches.

In some cases, machine learning models used by the defect indication engine may be continuously retrained using newly collected assessment data to improve detection accuracy over time. As the defect indication engine assesses devices and generates assessment results, the newly collected assessment data may be added to training datasets used to train the machine learning models. The machine learning models may be periodically retrained using the expanded training datasets that include the newly collected assessment data. The retraining process may enable the machine learning models to learn from new examples of defects that were not present in the original training datasets, improving the ability of the models to detect similar defects in future assessments. The retraining process may also enable the machine learning models to adapt to changes in defect characteristics over time, such as changes in defect appearance that may result from changes in device manufacturing processes or materials. The continuous retraining of machine learning models using newly collected assessment data may result in progressive improvement in detection accuracy as the defect indication engine accumulates more assessment experience. The retraining may be performed automatically at scheduled intervals, such as daily, weekly, or monthly, or the retraining may be triggered when the amount of newly collected assessment data exceeds a threshold quantity.

In some cases, the defect indication engine may generate statistical reports showing defect frequency distributions. The statistical reports may aggregate assessment results across multiple devices to provide summary statistics about the frequency of different defect types. For example, a statistical report may show the percentage of assessed devices that exhibited cracks, the percentage that exhibited scratches, the percentage that exhibited dead pixels, and the percentage that exhibited other defect types. The statistical reports may break down defect frequency distributions by device model, by time period, by assessment location, or by other categorization criteria. The statistical reports may include visualizations such as bar charts, pie charts, histograms, or trend lines that graphically represent the defect frequency distributions. The statistical reports may enable quality control insights for device refurbishment operations by revealing which defect types are most common, which device models are most prone to defects, and how defect rates are changing over time. Quality control personnel may use the insights from the statistical reports to allocate inspection resources, prioritize remediation efforts, or identify opportunities for process improvements. The statistical reports may be generated on demand in response to user requests, or the statistical reports may be generated automatically at scheduled intervals and distributed to designated recipients.

In some cases, predictive analytics may be employed to estimate future defect rates based on historical patterns. The predictive analytics may analyze historical assessment data to identify patterns and trends in defect occurrence over time. Based on the identified patterns and trends, the predictive analytics may generate forecasts of expected defect rates for future time periods. For example, if historical data shows that defect rates for a particular device model have been increasing at a consistent rate over the past several months, the predictive analytics may forecast that defect rates will continue to increase at a similar rate in the coming months. The predictive analytics may employ statistical forecasting techniques, time series analysis, or machine learning models trained to predict future values based on historical data. The forecasts generated by the predictive analytics may inform planning decisions, such as staffing levels for inspection and remediation operations, inventory levels for replacement parts, or pricing strategies for device resale. The predictive analytics may also generate confidence intervals or uncertainty estimates that indicate the range of possible future defect rates, enabling decision-makers to account for uncertainty in the forecasts when making planning decisions.

In some cases, the defect indication engine may flag unusual defect patterns that deviate from historical norms. The defect indication engine may establish historical norms for defect rates and defect type distributions based on accumulated assessment data. The historical norms may represent the typical or expected defect characteristics for devices of a particular model, from a particular manufacturing batch, or assessed during a particular time period. As new assessments are performed, the defect indication engine may compare the defect patterns observed in the new assessments to the established historical norms. When the defect patterns observed in new assessments deviate from the historical norms by more than a threshold amount, the defect indication engine may flag the unusual defect patterns for review. The flagging of unusual defect patterns may alert quality control personnel to potential systematic issues with specific device batches. For example, if devices from a newly received batch exhibit a defect rate that is substantially higher than the historical norm for devices of the same model, the flagging may indicate that the batch may have been affected by a manufacturing defect or damage during shipping. The flagging of unusual defect patterns may enable early detection of systematic issues, allowing quality control personnel to investigate the root cause of the unusual patterns and take corrective action before additional affected devices are processed or distributed.

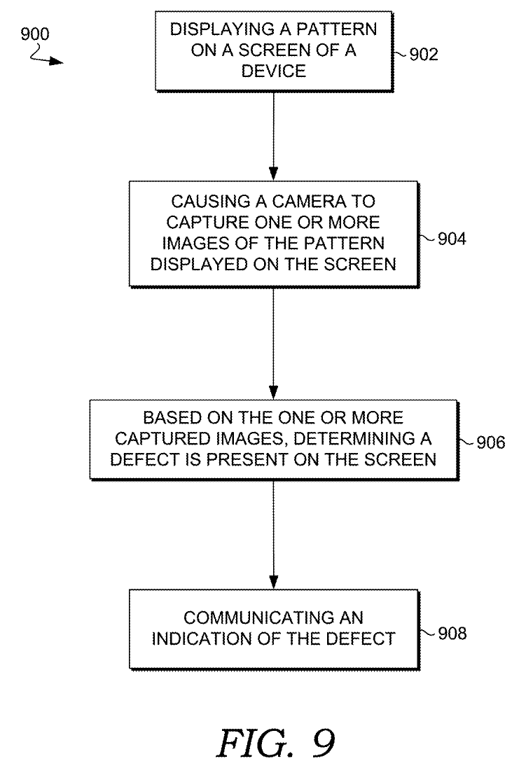

Referring to FIG. 9, a method 900 for assessing screen damage on a device is illustrated. The method 900 may be performed by components of the operating environment 100, such as the defect indication engine 114 and associated components including the pattern displayer 116, the image capturer 118, the defect determiner 120, and the indication communicator 122. In some cases, one or more computer storage media having computer-executable instructions embodied thereon may, when executed by one or more processors, cause the one or more processors to perform the method 900 for assessing screen damage on a device.

The method 900 begins at a step 902, where a pattern is displayed on a screen of a device. The step 902 may be performed by the pattern displayer 116. The pattern displayer 116 may display one or more patterns on the screen 202 of the user device 102. In some cases, the pattern displayer 116 may display a first pattern that is used to identify the user device 102 as a subject device scheduled for assessment, such as the optical codes 302 described with reference to FIG. 3. In some cases, the pattern displayer 116 may display a second pattern that is used by the defect indication engine 114 to determine whether there are any screen defects on the screen 202, such as the patterns at various orientations described with reference to FIGS. 4A-4E. The pattern may comprise solid colors, gradients, checkerboard patterns, horizontal and vertical lines, text patterns, geometric shapes, dynamic patterns, or other pattern types suitable for highlighting specific issues on the screen 202 such as cracks, smudges, scratches, light bleeding, bright spots, dead pixels, and screen burn. In some cases, the pattern may be static on the screen 202, or the pattern may be dynamic such that the pattern is rotated or moved across the screen 202.

With continued reference to FIG. 9, the method 900 proceeds to a step 904, where a camera is caused to capture one or more images of the pattern displayed on the screen. The step 904 may be performed by the image capturer 118. The image capturer 118 may cause the camera 104 to capture one or more images of the pattern displayed on the screen 202 of the user device 102. In some cases, the camera 104 may be the front-screen camera 204 located on a front of the user device 102, and the front-screen camera 204 may capture the one or more images by capturing a reflection of the pattern on the mirror 504 as described with reference to FIG. 5. In some cases, the camera 104 may be the external camera 602 located on a second user device separate from the user device 102, and the external camera 602 may capture the one or more images by facing the user device 102 and capturing the pattern on the screen 202 as described with reference to FIG. 6. The imagery captured by the camera 104 may be a video comprising a plurality of frames, or the imagery may be one or more still images. In some cases, the user device 102 and the camera 104 may be paired using a short-range communication protocol such that the camera 104 can communicate the captured images 702 of the pattern to the defect indication engine 114 via the image capturer 118.

The method 900 proceeds to a step 906, where, based on the one or more captured images, a defect is determined to be present on the screen. The step 906 may be performed by the defect determiner 120. The defect determiner 120 may compare the captured images 702 to the reference images 704 to determine if there is the perturbation 708 that meets or exceeds the deviation threshold 706. In some cases, the reference images 704 may be normalized images corresponding to no defects on the screen 202 of the user device 102. The perturbation 708 may be a deviation from at least one of the reference images 704, and the perturbation 708 may include distortions, changes in color, refractions of light, or other differences indicative of screen damage. If the perturbation 708 meets or exceeds the deviation threshold 706, then the defect determiner 120 may determine that there are one or more of the defects 710 on the screen 202. If the perturbation 708 does not meet or exceed the deviation threshold 706, then the defect determiner 120 may determine that there are no defects on the screen 202. In some cases, the defect determiner 120 may use artificial intelligence to determine whether the defects 710 are present on the screen 202 of the user device 102.

With continued reference to FIG. 9, the method 900 concludes at a step 908, where an indication of the defect is communicated. The step 908 may be performed by the indication communicator 122. The indication communicator 122 may communicate the indication 802 of the defects 710 for display at the user device 102 or at a remote display device such as the computing device 108. The indication 802 may include details such as the type of defect, the extent of the defect, and the location of the defect on the screen 202. In some cases, the indication communicator 122 may present a visual indication of the defects 710 to a technician on a display, and the visual indication may be selectable to view metadata associated with the defects 710. In some cases, the indication communicator 122 may store the indication 802 of one or more defects in the data store 112 for later access by a user. In some cases, the indication communicator 122 may generate the recommendation 804 relating to how the defects 710 should be addressed. The recommendation 804 may include instructions on whether to buff or clean the screen 202, whether to repair the screen 202, whether to replace the screen 202, whether to refurbish the user device 102, or whether to insure the user device 102. In some cases, the indication communicator 122 may generate the recommendation 804 that grades the user device 102 for resale and reuse based on the defects 710 detected on the screen 202.

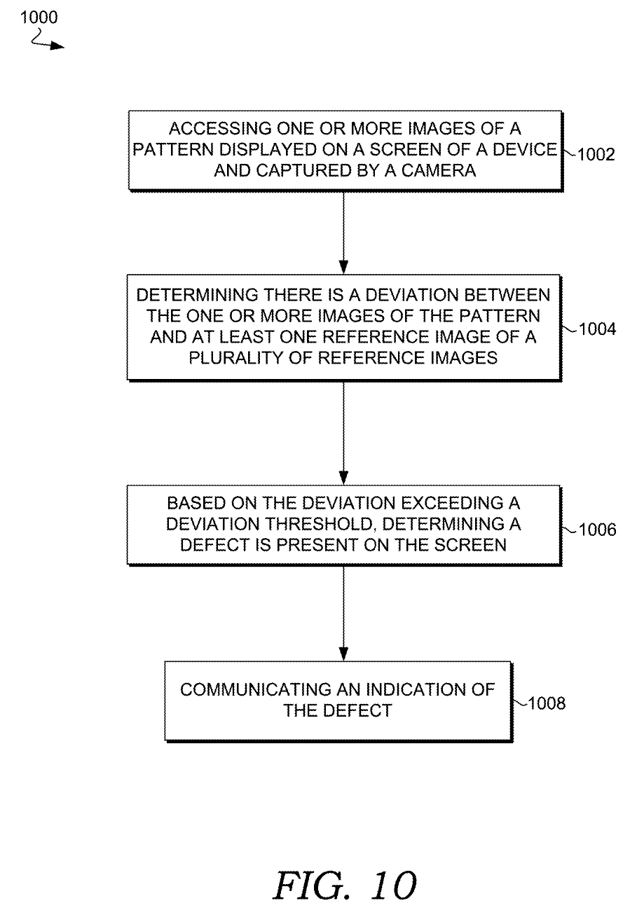

Referring to FIG. 10, a method 1000 for assessing screen damage on a device is illustrated. The method 1000 may be performed by components of the operating environment 100, such as the defect indication engine 114 and associated components including the image capturer 118, the defect determiner 120, and the indication communicator 122. In some cases, one or more computer storage media having computer-executable instructions embodied thereon may, when executed by one or more processors, cause the one or more processors to perform the method 1000 for assessing screen damage on a device.

The method 1000 begins at a step 1002, where one or more images of a pattern displayed on a screen of a device and captured by a camera are accessed. The step 1002 may be performed by the defect determiner 120. The defect determiner 120 may receive the captured images 702 of the pattern from the image capturer 118. The captured images 702 may be images of a pattern displayed on the screen 202 of the user device 102 that have been captured by the camera 104, such as the front-screen camera 204 or the external camera 602. In some cases, the captured images 702 may include images of the pattern at various orientations, such as the first pattern orientation 402, the second pattern orientation 404, the third pattern orientation 406, the fourth pattern orientation 408, or the fifth pattern orientation 410. The defect determiner 120 may access the captured images 702 from the data store 112, from the image capturer 118, or from another component of the operating environment 100 that stores or transmits the captured images 702.

With continued reference to FIG. 10, the method 1000 proceeds to a step 1004, where a deviation between the one or more images of the pattern and at least one reference image of a plurality of reference images is determined. The step 1004 may be performed by the defect determiner 120. The defect determiner 120 may analyze the captured images 702 by comparing the captured images 702 to the reference images 704 to determine if there is the perturbation 708 in the captured images 702. The reference images 704 may be images corresponding to the screen 202 without defects, providing a baseline for comparison. In some cases, the reference images 704 may be normalized images where pixel values have been adjusted so that the pixel values fall within a specific range. The defect determiner 120 may compare each image of the captured images 702 to each reference image of the reference images 704 to identify deviations between the captured images 702 and the reference images 704. The perturbation 708 may be a deviation from at least one of the reference images 704, and the perturbation 708 may include distortions, changes in color, refractions of light, or other differences indicative of screen damage. In some cases, the defect determiner 120 may compare the captured images 702 to the reference images 704 frame by frame to determine if there are any perturbations.

The method 1000 proceeds to a step 1006, where, based on the deviation exceeding a deviation threshold, a defect is determined to be present on the screen. The step 1006 may be performed by the defect determiner 120. The defect determiner 120 may evaluate whether the perturbation 708 in the captured images 702 meets or exceeds the deviation threshold 706. In some cases, the defect determiner 120 may apply a respective deviation threshold 706 to each of the detected perturbations 708, where each perturbation type corresponds to a specific deviation threshold 706. If the perturbation 708 meets or exceeds the deviation threshold 706, then the defect determiner 120 may determine that there are one or more of the defects 710 on the screen 202. If the perturbation 708 does not meet or exceed the deviation threshold 706, then the defect determiner 120 may determine that there are no defects on the screen 202. In some cases, the defect determiner 120 may determine the type of defect based on the type of perturbation 708, such as one or more cracks, smudges, scratches, light bleeding, bright spots, dead pixels, or screen burns. In some cases, the defect determiner 120 may determine the extent of the defects 710 based on how much the deviation threshold 706 has been exceeded.

With continued reference to FIG. 10, the method 1000 concludes at a step 1008, where an indication of the defect is communicated. The step 1008 may be performed by the indication communicator 122. The indication communicator 122 may communicate the indication 802 of the defects 710 for display at the user device 102 or at a remote display device such as the computing device 108. The indication 802 may include details such as the type of defect, the extent of the defect, and the location of the defect on the screen 202. In some cases, the indication communicator 122 may present a visual indication of the defects 710 to a technician on a display, and the visual indication may be selectable to view metadata associated with the defects 710, such as a scratch pattern, reflectivity, contrast ratio, defect location, or depth of defect. In some cases, the indication communicator 122 may store the indication 802 of one or more defects in the data store 112 for later access by a user. In some cases, the indication communicator 122 may generate the recommendation 804 relating to a course of action on how to remedy the defects 710. The recommendation 804 may include instructions on whether to buff out one or more scratches, clean one or more smudges, replace the screen 202, provide a valuation for the user device 102, or determine an insurability of the user device 102.

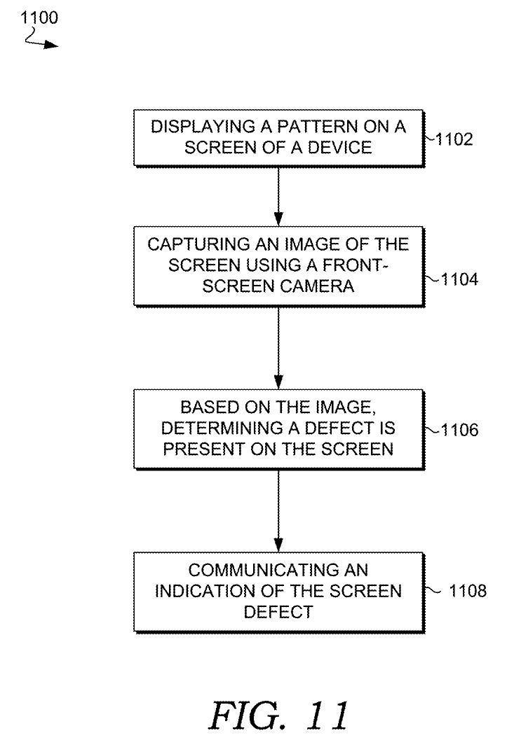

Referring to FIG. 11, a method 1100 for assessing screen damage on a device is illustrated. The method 1100 may be performed by components of the operating environment 100, such as the defect indication engine 114 and associated components including the pattern displayer 116, the image capturer 118, the defect determiner 120, and the indication communicator 122. In some cases, one or more computer storage media having computer-executable instructions embodied thereon may, when executed by one or more processors, cause the one or more processors to perform the method 1100 for assessing screen damage on a device. The method 1100 describes an assessment approach that utilizes the front-screen camera 204 located on the user device 102 to capture imagery of a displayed pattern, enabling the user device 102 to perform self-diagnosis of screen defects without requiring external equipment or physical presentation to a technician.

The method 1100 begins at a step 1102, where a pattern is displayed on a screen of a device. The step 1102 may be performed by the pattern displayer 116. The pattern displayer 116 may display a pattern on the screen 202 of the user device 102. The pattern may comprise solid colors, gradients, checkerboard patterns, horizontal and vertical lines, text patterns, geometric shapes, dynamic patterns, or other pattern types suitable for highlighting specific issues on the screen 202 such as cracks, smudges, scratches, light bleeding, bright spots, dead pixels, and screen burn. In some cases, the pattern may be static on the screen 202. In some cases, the pattern may be dynamic such that the pattern is rotated or moved across the screen 202. In some cases, the pattern displayer 116 may display the optical codes 302 on the screen 202 prior to displaying the pattern used for defect detection, enabling the defect indication engine 114 to verify that the user device 102 is the device scheduled for assessment before proceeding with defect analysis.

With continued reference to FIG. 11, the method 1100 proceeds to a step 1104, where an image of the screen is captured using a front-screen camera. The step 1104 may be performed by the image capturer 118. The image capturer 118 may cause the front-screen camera 204 to capture an image of the screen 202 with the pattern displayed thereon. The front-screen camera 204 may be located on a front aspect of the user device 102, and the front-screen camera 204 may capture the image by capturing a reflection of the pattern displayed on the screen 202. In some cases, the user device 102 may be positioned in front of the mirror 504 such that the pattern displayed on the screen 202 is reflected onto the mirror 504, and the front-screen camera 204 may capture the reflection of the pattern from the mirror 504. In some cases, the user device 102 may display instructions to present the screen 202 in an orientation such that the front aspect of the user device 102 is facing the mirror 504. The defect indication engine 114 may determine that the user device 102 is in the orientation using the image capturer 118 to capture an image of the reflection of the front aspect within the mirror 504. In some cases, the image of the screen 202 may comprise a plurality of frames captured as a video, or the image may be a single still image. The captured image may be provided to the defect indication engine 114 for analysis and defect determination.

The method 1100 proceeds to a step 1106, where, based on the image, a screen defect is determined to be present on the screen. The step 1106 may be performed by the defect determiner 120. The defect determiner 120 may compare the image of the screen 202 containing the pattern to the reference images 704 to determine if there is the perturbation 708 that meets or exceeds the deviation threshold 706. The reference images 704 may be images corresponding to the screen 202 without defects, providing a baseline for comparison. In some cases, the reference images 704 may be normalized images where pixel values have been adjusted so that the pixel values fall within a specific range. The perturbation 708 may be a deviation from at least one of the reference images 704, and the perturbation 708 may include distortions, changes in color, refractions of light, or other differences indicative of screen damage. If the perturbation 708 meets or exceeds the deviation threshold 706, then the defect determiner 120 may determine that there are one or more of the defects 710 on the screen 202. If the perturbation 708 does not meet or exceed the deviation threshold 706, then the defect determiner 120 may determine that there are no defects on the screen 202. In some cases, the defect determiner 120 may use artificial intelligence to determine whether the defects 710 are present on the screen 202 of the user device 102. In some cases, the defect determiner 120 may determine the type of defect based on the type of perturbation 708, such as one or more cracks, smudges, scratches, light bleeding, bright spots, dead pixels, or screen burns.

With continued reference to FIG. 11, the method 1100 concludes at a step 1108, where an indication of the screen defect is communicated. The step 1108 may be performed by the indication communicator 122. The indication communicator 122 may communicate the indication 802 of the defects 710 for display at the user device 102 or at a remote display device such as the computing device 108. The indication 802 may include details such as the type of defect, the extent of the defect, and the location of the defect on the screen 202. In some cases, the indication communicator 122 may present a visual indication of the defects 710 to a technician on a display, and the visual indication may be selectable to view metadata associated with the defects 710, such as a scratch pattern, reflectivity, contrast ratio, defect location, or depth of defect. In some cases, the indication communicator 122 may store the indication 802 of one or more defects in the data store 112 for later access by a user. In some cases, the indication communicator 122 may generate the recommendation 804 relating to a course of action on how to remedy the defects 710. The recommendation 804 may include instructions on whether to buff out one or more scratches, clean one or more smudges, replace the screen 202, provide a valuation for the user device 102, or determine an insurability of the user device 102. In some cases, the indication communicator 122 may generate the recommendation 804 that grades the user device 102 for resale and reuse based on the defects 710 detected on the screen 202.

The method 1100 enables the user device 102 to diagnose screen defects using the front-screen camera 204 without requiring an external camera or physical inspection by a technician. In some cases, a user may use the user device 102 to assess whether any screen defects are present by positioning the user device 102 in front of the mirror 504 and allowing the front-screen camera 204 to capture the reflection of the pattern displayed on the screen 202. The self-diagnosing capability provided by the method 1100 may enable remote assessment of device condition, allowing a remote person to use the front-screen camera 204 on the user device 102 to diagnose any issues with the screen 202 of the user device 102 without requiring the user device 102 to be physically transported to a technician.

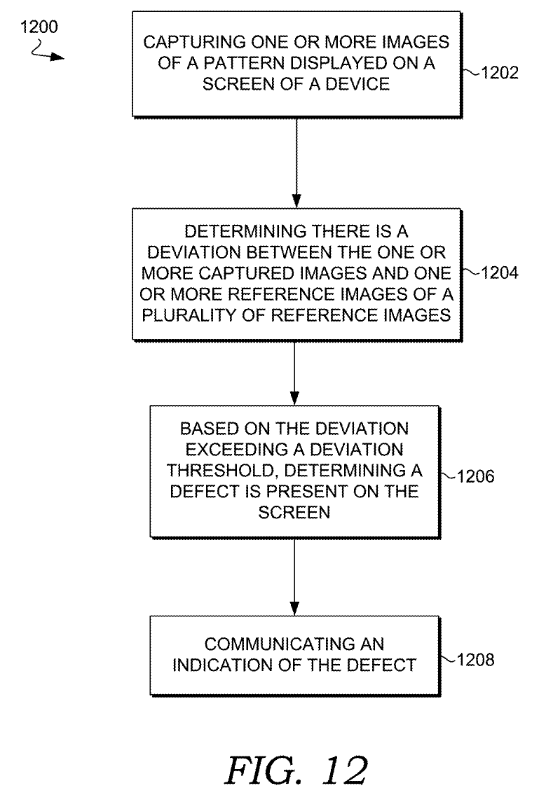

Referring to FIG. 12, a method 1200 for assessing screen damage on a device is illustrated. The method 1200 may be performed by components of the operating environment 100, such as the defect indication engine 114 and associated components including the pattern displayer 116, the image capturer 118, the defect determiner 120, and the indication communicator 122. In some cases, one or more computer storage media having computer-executable instructions embodied thereon may, when executed by one or more processors, cause the one or more processors to perform the method 1200 for assessing screen damage on a device.

The method 1200 begins at a step 1202, where one or more images of a pattern displayed on a screen of a device are captured. The step 1202 may be performed by the pattern displayer 116 and the image capturer 118. The pattern displayer 116 may display a pattern on the screen 202 of the user device 102, and the image capturer 118 may capture one or more images of the pattern using the camera 104. In some cases, the camera 104 may be the external camera 602 located on a second user device separate from the user device 102. The external camera 602 may capture the one or more images of the pattern displayed on the screen 202 of the user device 102 from a distance separating the user device 102 from the external camera 602. The external camera 602 may be aimed at the screen 202 to capture the pattern displayed on the user device 102. In some cases, the pattern may comprise solid colors, gradients, checkerboard patterns, horizontal and vertical lines, text patterns, geometric shapes, dynamic patterns, or other pattern types suitable for highlighting specific issues on the screen 202 such as cracks, smudges, scratches, light bleeding, bright spots, dead pixels, and screen burn. In some cases, the pattern displayer 116 may display the optical codes 302 on the screen 202 prior to displaying the pattern used for defect detection, enabling the defect indication engine 114 to verify that the user device 102 is the device scheduled for assessment before proceeding with defect analysis.

With continued reference to FIG. 12, the method 1200 proceeds to a step 1204, where a deviation between the one or more captured images and one or more reference images of a plurality of reference images is determined. The step 1204 may be performed by the defect determiner 120. The defect determiner 120 may analyze the captured images 702 by comparing the captured images 702 to the reference images 704 to determine if there is the perturbation 708 in the captured images 702. The reference images 704 may be images corresponding to the screen 202 without defects, providing a baseline for comparison. In some cases, the reference images 704 may be normalized images where pixel values have been adjusted so that the pixel values fall within a specific range, such as between 0 and 1, to normalize the images. The defect determiner 120 may compare each image of the captured images 702 to each reference image of the reference images 704 to identify deviations between the captured images 702 and the reference images 704. The perturbation 708 may be a deviation from at least one of the reference images 704, and the perturbation 708 may include distortions, changes in color, refractions of light, or other differences indicative of screen damage. In some cases, the defect determiner 120 may compare the captured images 702 to the reference images 704 frame by frame to determine if there are any perturbations.

The method 1200 proceeds to a step 1206, where, based on the deviation exceeding a deviation threshold, a defect is determined to be present on the screen. The step 1206 may be performed by the defect determiner 120. The defect determiner 120 may evaluate whether the perturbation 708 in the captured images 702 meets or exceeds the deviation threshold 706. In some cases, the defect determiner 120 may apply a respective deviation threshold 706 to each of the detected perturbations 708, where each perturbation type corresponds to a specific deviation threshold 706. If the perturbation 708 meets or exceeds the deviation threshold 706, then the defect determiner 120 may determine that there are one or more of the defects 710 on the screen 202. If the perturbation 708 does not meet or exceed the deviation threshold 706, then the defect determiner 120 may determine that there are no defects on the screen 202. In some cases, the defect determiner 120 may determine the type of defect based on the type of perturbation 708, such as one or more cracks, smudges, scratches, light bleeding, bright spots, dead pixels, or screen burns. In some cases, the defect determiner 120 may determine the extent of the defects 710 based on how much the deviation threshold 706 has been exceeded. In some cases, the defect determiner 120 may use artificial intelligence to determine whether the defects 710 are present on the screen 202 of the user device 102.

With continued reference to FIG. 12, the method 1200 concludes at a step 1208, where an indication of the defect is communicated. The step 1208 may be performed by the indication communicator 122. The indication communicator 122 may communicate the indication 802 of the defects 710 for display at the user device 102 or at a remote display device such as the computing device 108. The indication 802 may include details such as the type of defect, the extent of the defect, and the location of the defect on the screen 202. In some cases, the indication communicator 122 may present a visual indication of the defects 710 to a technician on a display, and the visual indication may be selectable to view metadata associated with the defects 710, such as a scratch pattern, reflectivity, contrast ratio, defect location, or depth of defect. In some cases, the indication communicator 122 may store the indication 802 of one or more defects in the data store 112 for later access by a user. In some cases, the indication communicator 122 may generate the recommendation 804 relating to a course of action on how to remedy the defects 710. The recommendation 804 may include instructions on whether to buff out one or more scratches, clean one or more smudges, replace the screen 202, provide a valuation for the user device 102, or determine an insurability of the user device 102. In some cases, the indication communicator 122 may generate the recommendation 804 that grades the user device 102 for resale and reuse based on the defects 710 detected on the screen 202.

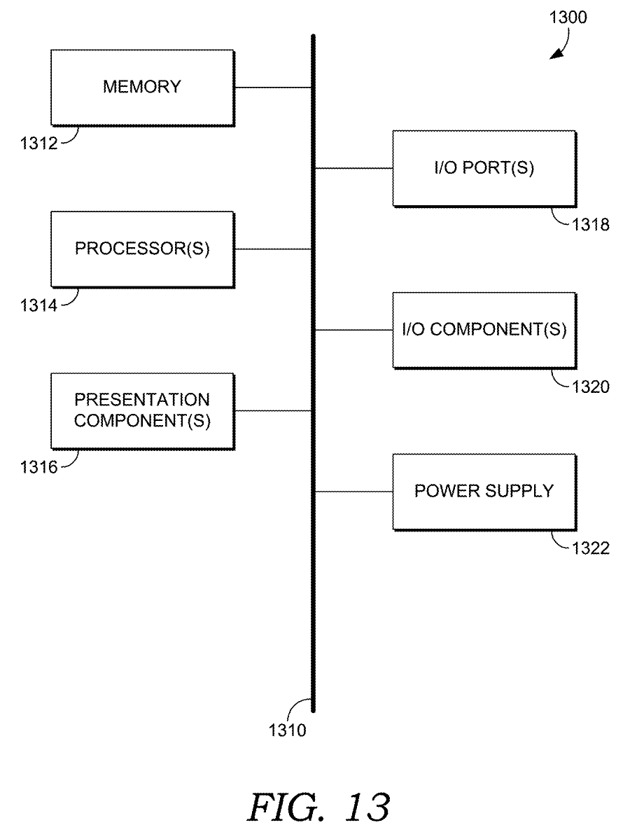

Referring to FIG. 13, a computing device 1300 suitable for implementing aspects of the technology is illustrated. The computing device 1300 is an example of a computing environment and is not intended to suggest any limitation as to the scope of use or functionality of the technology. The computing device 1300 should not be interpreted as having any dependency or requirement relating to any one or combination of components illustrated.

The computing device 1300 includes a bus 1310 that directly or indirectly couples several components. The bus 1310 represents what may be one or more buses, such as an address bus, a data bus, or a combination thereof. Connected to the bus 1310 are a memory 1312, one or more processors 1314, one or more presentation components 1316, one or more I/O ports 1318, one or more I/O components 1320, and a power supply 1322.

With continued reference to FIG. 13, the memory 1312 includes computer storage media in the form of volatile or non-volatile memory. The memory 1312 may be removable, non-removable, or a combination thereof. Example hardware devices that may serve as the memory 1312 include solid-state memory, hard drives, and optical-disc drives. The memory 1312 may store information including data, computer instructions such as software program instructions, routines, or services, or models used in embodiments of the described technologies. In some cases, the memory 1312 may store computer instructions for implementing functional aspects of the defect indication engine 114.

The one or more processors 1314 read data from various entities such as the memory 1312 or the I/O components 1320. The one or more processors 1314 may execute computer-executable instructions stored in the memory 1312 to perform operations described herein, such as displaying a pattern on a screen of a device, causing a camera to capture one or more images of the pattern, determining a defect is present on the screen based on the captured images, and communicating an indication of the defect.

The one or more presentation components 1316 present data indications to a user or other device. Example presentation components include a display device, a speaker, a printing component, and a vibrating component. In some cases, the one or more presentation components 1316 may be used to display the indication 802 of the defects 710 to a technician or to display the recommendation 804 relating to how the defects 710 should be addressed.

The one or more I/O ports 1318 allow the computing device 1300 to be logically coupled to other devices, including the I/O components 1320, some of which may be built-in. The one or more I/O ports 1318 may enable communication between the computing device 1300 and external devices such as the user device 102, the camera 104, or other components of the operating environment 100.

The one or more I/O components 1320 may include illustrative components such as a microphone, a joystick, a game pad, a satellite dish, a scanner, a printer, or a wireless device. The I/O components 1320 may provide a natural user interface (NUI) that processes air gestures, voice, or other physiological inputs generated by a user. In some cases, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, or touch recognition associated with a display of the computing device 1300. The computing device 1300 may be equipped with depth cameras such as stereoscopic camera systems, infrared camera systems, or RGB camera systems, touchscreen technology, or combinations of these for gesture detection and recognition. The computing device 1300 may be equipped with accelerometers or gyroscopes that enable detection of motion. The output of the accelerometers or gyroscopes may be provided to the display of the computing device 1300 to render immersive augmented reality or virtual reality.

The power supply 1322 provides power to the computing device 1300. The power supply 1322 may be an internal power supply, an external power supply, a battery, or a combination thereof.

The computing device 1300 may be embodied as various types of devices. In some cases, the computing device 1300 may be a workstation. In some cases, the computing device 1300 may be a server, such as the server 110. In some cases, the computing device 1300 may be a laptop. In some cases, the computing device 1300 may be a handheld device, such as the smartphone 210, the tablet 214, or other mobile devices. In some cases, the computing device 1300 may be the computing device 108 or the user device 102. The computing device 1300 may implement functional aspects of the operating environment 100, such as one or more functions of the defect indication engine 114 to facilitate automated assessment of a screen on a device and determination of whether screen defects are present on the screen of the device.

The components of the screen damage assessment system may interact in a coordinated manner to perform automated assessment of screen damage on a device. The interaction between components may follow a flow that begins with pattern display, proceeds through image capture, continues with defect determination using deviation analysis, and concludes with indication communication. The functions performed during this flow may be distributed across multiple devices and components, enabling flexible deployment configurations that accommodate different assessment scenarios and requirements.

The flow of screen damage assessment may begin when a pattern is displayed on a screen of a device to be assessed. The pattern display function may be performed by a component executing on the device being assessed, where the component causes the screen to render a pattern suitable for defect detection. The pattern may be rendered using a graphics processing unit of the device being assessed, and the pattern may be selected from a library of patterns stored on the device or retrieved from a remote server. In some cases, the pattern display function may be initiated by a remote server that transmits instructions to the device being assessed, causing the device to display a specified pattern. The remote server may select the pattern based on the device model, the type of assessment being performed, or other criteria. The pattern display function may also include displaying an optical code that identifies the device being assessed, enabling verification that the device displaying the pattern is the device scheduled for assessment.

Following pattern display, the image capture function may be performed to capture one or more images of the pattern displayed on the screen. The image capture function may be performed by a camera located on the device being assessed, such as a front-screen camera, or by an external camera located on a separate device. When a front-screen camera is used, the device being assessed may be positioned in front of a reflective surface such that the front-screen camera can capture a reflection of the pattern displayed on the screen. The image capture function may capture a single image, a sequence of images, or a video comprising multiple frames. The captured images may be stored locally on the device performing the image capture, or the captured images may be transmitted to a remote server for processing. In some cases, the image capture function may be coordinated with the pattern display function such that images are captured at specific times during pattern display, such as when the pattern is at a particular orientation or when the pattern has completed a rotation cycle.

The defect determination function may be performed to analyze the captured images and determine whether defects are present on the screen. The defect determination function may compare the captured images to reference images that represent the expected appearance of the pattern when displayed on a screen without defects. The comparison may identify perturbations in the captured images, where a perturbation is a deviation from the expected appearance represented by the reference images. The perturbations may include distortions in the pattern, changes in color, refractions of light, or other differences that indicate the presence of screen damage. The defect determination function may apply deviation thresholds to the identified perturbations to determine whether the perturbations are indicative of defects. When a perturbation meets or exceeds a deviation threshold, the defect determination function may classify the perturbation as a defect and may determine the type, location, and severity of the defect based on the characteristics of the perturbation.

The defect determination function may be performed by a processor executing on the device being assessed, by a processor executing on a separate computing device, or by a processor executing on a remote server. When the defect determination function is performed on the device being assessed, the device may perform self-diagnosis of screen defects without requiring communication with external systems. When the defect determination function is performed on a separate computing device or remote server, the captured images may be transmitted from the device performing image capture to the device or server performing defect determination. The transmission may occur over a network connection, such as a wireless network connection or a wired network connection. In some cases, the defect determination function may be distributed across multiple devices, where a first device performs initial processing of the captured images and a second device performs detailed analysis to determine the presence and characteristics of defects.

Following defect determination, the indication communication function may be performed to communicate information about detected defects. The indication communication function may generate an indication that includes details about the detected defects, such as the type of each defect, the location of each defect on the screen, and the severity of each defect. The indication may be communicated for display on the device being assessed, on a separate computing device, or on a remote display device. The indication communication function may also generate a recommendation that suggests a course of action for addressing the detected defects, such as whether to repair the screen, replace the screen, or refurbish the device. The recommendation may be based on the type and severity of the detected defects, and the recommendation may include a valuation of the device based on the screen condition.

The distribution of functions across devices may vary depending on the assessment scenario and the capabilities of the available devices. In a first configuration, the device being assessed may perform all functions, including pattern display, image capture using a front-screen camera and reflective surface, defect determination, and indication communication. In the first configuration, the device being assessed may operate autonomously to diagnose screen defects without requiring communication with external systems or physical presentation to a technician. The autonomous operation may enable remote assessment of device condition, where a user in possession of the device can initiate and complete the assessment without requiring the device to be transported to an assessment facility.

In a second configuration, the device being assessed may perform pattern display, while a separate device performs image capture using an external camera. The captured images may be transmitted from the separate device to a computing device or server that performs defect determination. The computing device or server may then communicate the indication of detected defects to a display device accessible to a technician or other user. The second configuration may be suitable for assessment facilities where multiple devices are assessed in sequence, and where a fixed camera station captures images of patterns displayed on each device.

In a third configuration, the device being assessed may perform pattern display, and a front-screen camera on the device being assessed may perform image capture. The captured images may be transmitted from the device being assessed to a remote server that performs defect determination. The remote server may then communicate the indication of detected defects back to the device being assessed or to a separate display device. The third configuration may enable remote assessment where the device being assessed is in the possession of a user at a remote location, and where the defect determination function is performed by a centralized server that has access to reference images and trained models for defect detection.

The system may enable self-diagnosis by a device without requiring physical presentation to a technician through the use of a front-screen camera and a reflective surface. When a device is capable of displaying a pattern on the screen and capturing a reflection of the pattern using a front-screen camera, the device may perform the pattern display and image capture functions without external equipment. The captured images may be analyzed by a defect determination function executing on the device or on a remote server to determine whether defects are present on the screen. The indication of detected defects may be communicated to the user of the device or to a remote technician, enabling assessment of screen condition without requiring the device to be physically transported to an assessment facility or physically inspected by a technician.

The self-diagnosis capability may be initiated by a user in response to instructions displayed on the device or received from a remote support service. The instructions may guide the user to position the device in front of a reflective surface, such as a mirror, and to hold the device at a specified orientation. The device may display a pattern on the screen and capture images of the reflection of the pattern using the front-screen camera. The captured images may be transmitted to a remote server for defect determination, and the results of the assessment may be communicated back to the user or to a support representative. The self-diagnosis capability may reduce the time and resources associated with screen assessment by eliminating the need for physical transport of the device and enabling assessment to be performed at the location where the device is currently situated.

Referring to the drawings and description in general, having identified various components in the present disclosure, it should be understood that any number of components and arrangements might be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, or software. For instance, various functions may be carried out by a processor executing instructions stored in memory. As such, other arrangements and elements (e.g., machines, interfaces, functions, orders, and groupings of functions, etc.) can be used in addition to or instead of those shown.

### The following examples pertain to further embodiments.

Clause 1: A method of assessing screen damage on a device, the method comprising: displaying a pattern on a screen of the device; causing a camera to capture one or more images of the pattern displayed on the screen; based on the one or more captured images, determining a defect is present on the screen; and communicating an indication of the defect.

Clause 2: Clause 1, further comprising: displaying an optical code on the screen; matching the optical code to a subject device; and determining the screen of the device corresponds to the subject device.

Clause 3: Clause 2, wherein the pattern is displayed after determining the screen of the device corresponds to the subject device.

Clause 4: Any of Clauses 1-3, wherein the pattern comprises a solid color.

Clause 5: Any of Clauses 1-4, wherein the pattern comprises a transition between one or more colors.

Clause 6: Any of Clauses 1-5, wherein the pattern comprises black and white squares.

Clause 7: Any of Clauses 1-6, wherein the pattern comprises text in various fonts and sizes.

Clause 8: Any of Clauses 1-7, wherein the pattern comprises geometric shapes.

Clause 9: Any of Clauses 1-8, wherein the pattern comprises one or more lines.

Clause 10: Any of Clauses 1-9, wherein the pattern is a grid.

Clause 11: Any of Clauses 1-10, further comprising normalizing the pattern to determine a baseline.

Clause 12: Any of Clauses 1-11, wherein the pattern is rotated on the screen.

Clause 13: Any of Clauses 1-12, wherein the one or more images of the pattern are captured using a camera of the device on which the pattern is displayed.

Clause 14: Clause 13, wherein the camera is a front-screen camera located on a front of the device.

Clause 15: Any of Clauses 13-14, wherein the camera captures the one or more images by capturing a reflection of the pattern.

Clause 16: Any of Clauses 1-12, wherein the one or more images of the pattern are captured using a camera that is an external camera not located on the device.

Clause 17: Any of Clauses 1-16, wherein each image of the one or more images of the pattern is compared to each reference image of a plurality of reference images.

Clause 18: Clause 17, wherein the plurality of reference images represents the screen without the defect.

Clause 19: Any of Clauses 1-18, further comprising determining the one or more images of the pattern exceed a deviation threshold, wherein the deviation threshold corresponds to a perturbation in the one or more images of the pattern.

Clause 20: Any of Clauses 17-19, wherein the perturbation is a deviation from at least one of the reference images.

Clause 21: Any of Clauses 19-20, further comprising: determining there is a deviation between the one or more images of the pattern and one or more of the reference images; and based on the deviation exceeding the deviation threshold, communicating the indication of the defect.

Clause 22: Any of Clauses 19-21, wherein the defect is determined based on the perturbation being a change in color within the one or more images of the pattern.

Clause 23: Any of Clauses 19-22, wherein the defect is determined based on the perturbation being a refraction of light off the screen.

Clause 24: Any of Clauses 1-23, wherein the indication of the defect on the screen comprises a cracked screen, a scratched screen, a smudge on the screen, or one or more dead pixels on the screen.

Clause 25: Any of Clauses 1-24, further comprising determining the defect on the screen using artificial intelligence (AI).

Clause 26: Any of Clauses 1-25, wherein communicating the indication of the defect comprises recommending a course of action based on the defect.

Clause 27: Clause 26, wherein the course of action comprises buffing out one or more scratches, cleaning one or more smudges, replacing the screen, providing a valuation for the device, or determining an insurability of the device.

Clause 28: One or more computer storage media having computer-executable instructions embodied thereon that, when executed by one or more processors, cause the one or more processors to perform operations comprising: accessing one or more images of a pattern displayed on a screen of a device and captured by a camera; determining there is a deviation between the one or more images of the pattern and at least one reference image of a plurality of reference images; based on the deviation exceeding a deviation threshold, determining a defect is present on the screen; and communicating an indication of the defect.

Clause 29: Clause 28, further comprising: displaying an optical code on the screen; matching the optical code to a subject device; and determining the screen of the device corresponds to the subject device.

Clause 30: Any of Clauses 28-29, wherein the one or more images of the pattern are accessed after determining the screen corresponds to the subject device.

Clause 31: Any of Clauses 28-30, wherein the pattern comprises a solid color.

Clause 32: Any of Clauses 28-31, wherein the pattern comprises a transition between one or more colors.

Clause 33: Any of Clauses 28-32, wherein the pattern comprises black and white squares.

Clause 34: Any of Clauses 28-33, wherein the pattern comprises text in various fonts and sizes.

Clause 35: Any of Clauses 28-34, wherein the pattern comprises geometric shapes.

Clause 36: Any of Clauses 28-35, wherein the pattern comprises one or more lines.

Clause 37: Any of Clauses 28-36, wherein the pattern is a grid.

Clause 38: Any of Clauses 28-37, wherein the camera is a front-screen camera located on a front of the device.

Clause 39: Any of Clauses 28-38, wherein the camera captures the one or more images of the pattern by capturing a reflection of the pattern.

Clause 40: Any of Clauses 28-37, wherein the camera is an external camera not located on the device.

Clause 41: Any of Clauses 28-40, wherein each image of the one or more images of the pattern is compared to each reference image of the plurality of reference images.

Clause 42: Any of Clauses 28-41, wherein the plurality of reference images represents the screen without the defect.

Clause 43: Any of Clauses 28-42, further comprising determining the one or more images of the pattern exceed a deviation threshold, wherein the deviation threshold corresponds to a perturbation in the one or more images of the pattern.

Clause 44: Clause 43, wherein the perturbation is a deviation from at least one of the reference images.

Clause 45: Any of Clauses 43-44, wherein the defect is determined based on the perturbation being a change in color within the one or more images of the pattern.

Clause 46: Any of Clauses 43-45, wherein the defect is determined based on the perturbation being a refraction of light off the screen.

Clause 47: Any of Clauses 28-46, wherein the indication of the defect on the screen comprises a cracked screen, a scratched screen, a smudge on the screen, or one or more dead pixels on the screen.

Clause 48: Any of Clauses 28-47, further comprising determining the defect in the screen using artificial intelligence (AI).

Clause 49: Any of Clauses 28-48, wherein communicating the indication of the defect comprises recommending a course of action based on the defect.

Clause 50: Clause 49, wherein the course of action comprises buffing out one or more scratches, cleaning one or more smudges, replacing the screen, providing a valuation for the device, or determining an insurability of the device.

Clause 51: A system comprising: a device; a front-screen camera on the device; at least one processor; and one or more computer storage media storing computer readable instructions thereon that when executed by the at least one processor cause the at least one processor to perform operations comprising: displaying a pattern on a screen of the device; capturing an image of the screen using the front-screen camera; based on the image, determining a defect is present on the screen; and communicating an indication of the defect.

Clause 52: Clause 51, further comprising: displaying an optical code on the screen; matching the optical code to a subject device; and determining the screen of the device corresponds to the subject device.

Clause 53: Any of Clauses 51-52, wherein the pattern is displayed on the screen after determining the device corresponds to the subject device.

Clause 54: Any of Clauses 51-53, wherein the pattern comprises a solid color.

Clause 55: Any of Clauses 51-54, wherein the pattern comprises a transition between one or more colors.

Clause 56: Any of Clauses 51-55, wherein the pattern comprises black and white squares.

Clause 57: Any of Clauses 51-56, wherein the pattern comprises text in various fonts and sizes.

Clause 58: Any of Clauses 51-57, wherein the pattern comprises geometric shapes.

Clause 59: Any of Clauses 51-58, wherein the pattern comprises one or more lines.

Clause 60: Any of Clauses 51-59, wherein the pattern is a grid.

Clause 61: Any of Clauses 51-60, further comprising normalizing the pattern to determine a baseline.

Clause 62: Any of Clauses 51-61, wherein the pattern is rotated on the screen.

Clause 63: Any of Clauses 51-62, wherein the front-screen camera captures the image of the screen by capturing a reflection of the screen in a mirror.

Clause 64: Any of Clauses 51-63, wherein the image of the screen comprises a plurality of frames, and wherein each frame of the plurality of frames is compared to each reference image of a plurality of reference images.

Clause 65: Any of Clauses 51-64, wherein the plurality of reference images represents the screen without the defect.

Clause 66: Any of Clauses 51-65, further comprising determining the image exceeds a deviation threshold, wherein the deviation threshold corresponds to a perturbation in the image.

Clause 67: Any of Clauses 64-66, wherein the perturbation is a deviation from at least one of the reference images.

Clause 68: Any of Clauses 64-67, further comprising: determining there is a deviation between at least one frame of the plurality of frames and at least one reference image of the plurality of reference images; and based on the deviation exceeding the deviation threshold, communicating the indication of the defect.

Clause 69: Any of Clauses 66-67, wherein the defect is determined based on the perturbation being a change in color within the pattern on the screen.

Clause 70: Any of Clauses 66-67 and 69, wherein the defect is determined based on the perturbation being a refraction of light off the screen.

Clause 71: Any of Clauses 51-70, wherein the indication of the defect comprises a cracked screen, a scratched screen, a smudge on the screen, or one or more dead pixels on the screen.

Clause 72: Any of Clauses 51-71, further comprising determining the defect using artificial intelligence (AI).

Clause 73: Clause 72, wherein the AI recommends a course of action based on the defect.

Clause 74: Clause 73, wherein the course of action comprises buffing out one or more scratches, cleaning one or more smudges, replacing the screen, providing a valuation for the device, or determining an insurability of the device.

Clause 75: A method of assessing screen damage on a device, the method comprising: capturing one or more images of a pattern displayed on a screen of a device; determining there is a deviation between the one or more captured images and one or more reference images of a plurality of reference images; based on the deviation exceeding a deviation threshold, determining a defect is present on the screen; and communicating an indication of the defect.

Clause 76: Clause 75, further comprising: capturing an optical code displayed on the screen; matching the optical code to a subject device; and determining the screen of the device corresponds to the subject device.

Clause 77: Any of Clauses 75-76, wherein the one or more images of the pattern are captured after determining the device corresponds to the subject device.

Clause 78: Any of Clauses 75-77, wherein the pattern comprises a solid color.

Clause 79: Any of Clauses 75-78, wherein the pattern comprises a transition between one or more colors.

Clause 80: Any of Clauses 75-79, wherein the pattern comprises black and white squares.

Clause 81: Any of Clauses 75-80, wherein the pattern comprises text in various fonts and sizes.

Clause 82: Any of Clauses 75-81, wherein the pattern comprises geometric shapes.

Clause 83: Any of Clauses 75-82, wherein the pattern comprises one or more lines.

Clause 84: Any of Clauses 75-83, wherein the pattern is a grid.

Clause 85: Any of Clauses 75-84, wherein the one or more images of the pattern are captured from a distance from the device.

Clause 86: Any of Clauses 75-85, wherein the one or more captured images are compared to each reference image of a plurality of reference images.

Clause 87: Any of Clauses 75-86, wherein the plurality of reference images represents the screen without the defect.

Clause 88: Any of Clauses 75-87, further comprising determining the one or more captured images exceed a deviation threshold, wherein the deviation threshold corresponds to a perturbation in the one or more images of the pattern.

Clause 89: Clause 88, wherein the perturbation is a deviation from at least one of the reference images.

Clause 90: Any of Clauses 88-89, wherein the defect is determined based on the perturbation being a change in color within the pattern displayed on the screen.

Clause 91: Any of Clauses 88-90, wherein the defect is determined based on the perturbation being a refraction of light off the screen.

Clause 92: Any of Clauses 75-91, wherein the indication of the defect comprises a cracked screen, a scratched screen, a smudge on the screen, or one or more dead pixels on the screen.

Clause 93: Any of Clauses 75-92, further comprising determining the defect using artificial intelligence (AI).

Clause 94: Clause 93, wherein the AI recommends a course of action based on the defect.

Clause 95: Clause 94, wherein the course of action comprises buffing out one or more scratches, cleaning one or more smudges, replacing the screen, providing a valuation of the device, or determining an insurability of the device.

Clause 96: Any of Clauses 1-95, wherein the pattern comprises concentric circles or rings of varying radii to detect radial distortions caused by impact damage.

Clause 97: Any of Clauses 1-96, wherein the pattern includes Moiré patterns that are sensitive to detecting subtle screen irregularities and pixel misalignments.

Clause 98: Any of Clauses 1-97, wherein the pattern incorporates sinusoidal wave patterns with varying frequencies and amplitudes to detect different scales of defects.

Clause 99: Any of Clauses 1-98, wherein the pattern includes diagonal line patterns at multiple angles to detect directional scratches.

Clause 100: Any of Clauses 1-99, wherein the pattern includes a combination of high-contrast edges and low-contrast gradients within the same display to simultaneously test for multiple defect types.

Clause 101: Any of Clauses 1-100, wherein the pattern comprises a series of progressively smaller geometric elements to assess the resolution limits affected by screen damage.

Clause 102: Any of Clauses 1-101, wherein the camera captures images at multiple exposure levels using bracketed exposure to detect defects that are visible under specific lighting conditions.

Clause 103: Any of Clauses 1-102, wherein the camera employs high dynamic range (HDR) imaging techniques to capture both bright spots and dark areas of the screen simultaneously.

Clause 104: Any of Clauses 1-103, wherein multiple images are captured at different focal distances to create a focus stack that reveals defects at various depths within the screen assembly.

Clause 105: Any of Clauses 1-104, wherein the camera captures images using different white balance settings to enhance detection of color-related defects.

Clause 106: Any of Clauses 1-105, wherein time-lapse capture is employed where multiple images are taken over a period of seconds to detect intermittent defects such as flickering pixels.

Clause 107: Any of Clauses 1-106, wherein the camera captures images at varying frame rates when recording video to detect refresh rate-related anomalies.

Clause 108: Any of Clauses 1-107, wherein the deviation threshold is dynamically adjusted based on a specific device model being assessed, accounting for known manufacturing tolerances of different screen types.

Clause 109: Any of Clauses 1-108, wherein multiple tiered thresholds are employed, where a first threshold indicates minor cosmetic defects and progressively higher thresholds indicate more severe functional defects.

Clause 110: Any of Clauses 1-109, wherein the deviation threshold is adjusted based on an intended end-use of the device, with stricter thresholds for devices intended for resale as like new and more lenient thresholds for devices intended for parts harvesting.

Clause 111: Any of Clauses 1-110, wherein the deviation threshold incorporates weighted factors where certain defect types are weighted more heavily than others.

Clause 112: Any of Clauses 1-111, wherein the deviation threshold is user-configurable through an administrative interface, allowing different organizations to set their own quality standards.

Clause 113: Any of Clauses 1-112, wherein the artificial intelligence employs trained convolutional neural networks (CNNs) or other image processing models trained on datasets comprising images of mobile device screens with various types of defects.

Clause 114: Any of Clauses 1-113, wherein a multi-model ensemble approach is utilized where multiple neural networks independently analyze the captured images and their outputs are combined through voting or averaging.

Clause 115: Any of Clauses 1-114, wherein a two-stage detection approach is employed where a first model performs coarse defect localization and a second model performs fine-grained defect classification.

Clause 116: Any of Clauses 1-115, wherein transfer learning is applied using models pre-trained on general image recognition tasks and fine-tuned on screen defect datasets.

Clause 117: Any of Clauses 1-116, wherein attention mechanisms are incorporated that focus computational resources on regions of the image most likely to contain defects.

Clause 118: Any of Clauses 1-117, wherein generative adversarial networks (GANs) are used to augment training data by generating synthetic images of various defect types.

Clause 119: Any of Clauses 1-118, wherein federated learning approaches are employed where model improvements are derived from multiple assessment locations without centralizing sensitive device data.

Clause 120: Any of Clauses 1-119, wherein detailed PDF reports are generated that include annotated images highlighting defect locations, defect classifications, and recommended remediation actions.

Clause 121: Any of Clauses 1-120, wherein real-time notifications are sent via SMS, email, or push notifications to designated technicians or quality control personnel.

Clause 122: Any of Clauses 1-121, further comprising integration with enterprise resource planning (ERP) systems to automatically update inventory records with device condition assessments.

Clause 123: Any of Clauses 1-122, wherein API endpoints are provided to allow third-party systems to query defect assessment results programmatically.

Clause 124: Any of Clauses 1-123, wherein machine-readable output formats such as JSON or XML are generated for integration with automated processing workflows.

Clause 125: Any of Clauses 1-124, wherein voice-based reporting is provided through integration with voice assistants, allowing hands-free operation in warehouse environments.

Clause 126: Any of Clauses 1-125, wherein ambient light sensors are used to adjust pattern brightness and contrast to maintain consistent detection accuracy across different lighting environments.

Clause 127: Any of Clauses 1-126, further comprising detecting and compensating for reflections from overhead lighting by analyzing multiple captured images and filtering out consistent reflection artifacts.

Clause 128: Any of Clauses 1-127, wherein temperature sensors are incorporated to account for screen behavior variations at different operating temperatures.

Clause 129: Any of Clauses 1-128, further comprising calibration routines that use a known reference surface to establish baseline conditions before each assessment session.

Clause 130: Any of Clauses 1-129, wherein humidity sensors are employed to detect conditions that could cause temporary condensation-related artifacts that should not be classified as permanent defects.

Clause 131: Any of Clauses 1-130, further comprising instructing users to position the device at specific angles relative to the camera or mirror to optimize defect visibility.

Clause 132: Any of Clauses 1-131, wherein a motorized fixture is employed to automatically rotate the device through multiple orientations during assessment.

Clause 133: Any of Clauses 1-132, further comprising utilizing accelerometer and gyroscope data from the device being assessed to track the orientation of the device and correlate defect visibility with specific viewing angles.

Clause 134: Any of Clauses 1-133, wherein multiple cameras positioned at different angles simultaneously capture images to provide comprehensive coverage without requiring device movement.

Clause 135: Any of Clauses 1-134, wherein a turntable mechanism rotates the device while maintaining a fixed camera position.

Clause 136: Any of Clauses 1-135, wherein crack length and branching complexity are measured in millimeters and reported as numerical values.

Clause 137: Any of Clauses 1-136, wherein dead pixel clusters are quantified by total affected area as a percentage of screen surface.

Clause 138: Any of Clauses 1-137, wherein scratch depth is estimated based on light refraction characteristics and reported on a standardized scale.

Clause 139: Any of Clauses 1-138, wherein screen burn severity is quantified based on the contrast differential between affected and unaffected areas.

Clause 140: Any of Clauses 1-139, wherein an overall screen condition score is calculated as a weighted combination of individual defect metrics, providing a single numerical grade for the device.

Clause 141: Any of Clauses 1-140, wherein a conveyor-based system transports devices past a fixed camera station for high-throughput assessment.

Clause 142: Any of Clauses 1-141, wherein multiple devices are arranged in a grid pattern and assessed simultaneously using a single high-resolution camera.

Clause 143: Any of Clauses 1-142, further comprising maintaining a queue of devices awaiting assessment and automatically processing the devices in sequence.

Clause 144: Any of Clauses 1-143, wherein parallel processing is employed where multiple assessment stations operate simultaneously and report results to a centralized database.

Clause 145: Any of Clauses 1-144, further comprising barcode or RFID scanning to automatically associate assessment results with specific device serial numbers in batch operations.

Clause 146: Any of Clauses 1-145, wherein assessment results are stored in a database and analyzed over time to identify trends in defect types across device models or manufacturing batches.

Clause 147: Any of Clauses 1-146, wherein machine learning models are continuously retrained using newly collected assessment data to improve detection accuracy over time.

Clause 148: Any of Clauses 1-147, further comprising generating statistical reports showing defect frequency distributions, enabling quality control insights for device refurbishment operations.

Clause 149: Any of Clauses 1-148, wherein predictive analytics are employed to estimate future defect rates based on historical patterns.

Clause 150: Any of Clauses 1-149, further comprising flagging unusual defect patterns that deviate from historical norms, potentially indicating systematic issues with specific device batches.

Embodiments described above may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of the present technology is described with specificity herein to meet statutory requirements. However, the description itself is not intended to limit the scope of this disclosure. Rather, the inventors have contemplated that the claimed or disclosed subject matter might also be embodied in other ways, to include different steps or combinations of steps similar to the ones described in this document, in conjunction with other present or future technologies. Moreover, although the terms “step” or “block” might be used herein to connote different elements of methods employed, the terms should not be interpreted as implying any particular order among or between various steps herein disclosed unless and except when the order of individual steps is explicitly stated.

For purposes of this disclosure, the words “including,” “having,” and other like words and their derivatives have the same broad meaning as the word “comprising,” and the word “accessing” comprises “receiving,” “referencing,” or “retrieving,” or derivatives thereof. Further, the word “communicating” has the same broad meaning as the word “receiving” or “transmitting,” as facilitated by software or hardware-based buses, receivers, or transmitters using communication media described herein.

In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

As further used herein, the term “train,” when referring to training a machine learning model, may mean training an untrained model, further training a previously trained model, fine-tuning a pre-trained model, or the like. “Train” is intended to broadly cover methods of machine learning using a dataset.

For purposes of a detailed discussion above, embodiments of the present technology are described with reference to a distributed computing environment. However, the distributed computing environment depicted herein is merely an example. Components can be configured for performing novel aspects of embodiments, where the term “configured for” or “configured to” can refer to “programmed to” perform particular tasks or implement particular abstract data types using code. Further, while embodiments of the present technology may generally refer to the distributed data object management system and the schematics described herein, it is understood that the techniques described may be extended to other implementation contexts.

From the foregoing, it will be seen that this technology is one well-adapted to attain all the ends and objects described above, including other advantages that are obvious or inherent to the structure. It will be understood that certain features and subcombinations are of utility and may be employed without reference to other features and subcombinations. This is contemplated by and is within the scope of the claims. Since many possible embodiments of the described technology may be made without departing from the scope, it is to be understood that all matter described herein or illustrated by the accompanying drawings is to be interpreted as illustrative and not in a limiting sense.

1. A method of assessing screen damage on a device, the method comprising:
displaying a pattern on a screen of the device;
causing a camera to capture one or more images of the pattern displayed on the screen;
based on the one or more captured images, determining a defect is present on the screen; and
communicating an indication of the defect.

2. The method of claim 1, further comprising:
displaying an optical code on the screen;
matching the optical code to a subject device; and
determining the screen of the device corresponds to the subject device.

3. The method of claim 2, wherein the pattern is displayed after determining the screen of the device corresponds to the subject device.

4. The method of claim 1, wherein the pattern comprises one or more lines forming a grid.

5. The method of claim 4, wherein the pattern is rotated on the screen.

6. The method of claim 1, wherein the one or more images of the pattern are captured using a front-screen camera located on a front of the device.

7. The method of claim 6, wherein the front-screen camera captures the one or more images by capturing a reflection of the pattern.

8. The method of claim 1, wherein determining the defect is present on the screen comprises:
comparing each image of the one or more captured images to each reference image of a plurality of reference images; and
determining a perturbation in the one or more captured images exceeds a deviation threshold.

9. The method of claim 8, wherein the perturbation is a deviation from at least one of the plurality of reference images, and wherein the plurality of reference images represents the screen without the defect.

10. The method of claim 1, further comprising determining the defect on the screen using artificial intelligence.

11. The method of claim 1, wherein communicating the indication of the defect comprises recommending a course of action based on the defect, wherein the course of action comprises buffing out one or more scratches, cleaning one or more smudges, replacing the screen, providing a valuation for the device, or determining an insurability of the device.

12. One or more computer storage media having computer-executable instructions embodied thereon that, when executed by one or more processors, cause the one or more processors to perform operations comprising:
accessing one or more images of a pattern displayed on a screen of a device and captured by a camera;
determining there is a deviation between the one or more images of the pattern and at least one reference image of a plurality of reference images;
based on the deviation exceeding a deviation threshold, determining a defect is present on the screen; and
communicating an indication of the defect.

13. The one or more computer storage media of claim 12, wherein the operations further comprise:
displaying an optical code on the screen;
matching the optical code to a subject device; and
determining the screen of the device corresponds to the subject device, wherein the one or more images of the pattern are accessed after determining the screen corresponds to the subject device.

14. The one or more computer storage media of claim 12, wherein the camera is a front-screen camera located on a front of the device, and wherein the front-screen camera captures the one or more images of the pattern by capturing a reflection of the pattern.

15. The one or more computer storage media of claim 12, wherein the deviation is a perturbation comprising a change in color within the one or more images of the pattern or a refraction of light off the screen.

16. The one or more computer storage media of claim 15, wherein the indication of the defect on the screen comprises a cracked screen, a scratched screen, a smudge on the screen, or one or more dead pixels on the screen.

17. A system comprising:
a device having a screen;
a camera;
at least one processor; and
one or more computer storage media storing computer readable instructions thereon that when executed by the at least one processor cause the at least one processor to perform operations comprising:
displaying a pattern on the screen of the device;
capturing an image of the screen using the camera;
based on the image, determining a defect is present on the screen; and
communicating an indication of the defect.

18. The system of claim 17, wherein the camera is a front-screen camera located on a front of the device, and wherein the front-screen camera captures the image of the screen by capturing a reflection of the screen in a mirror.

19. The system of claim 17, wherein determining the defect is present on the screen comprises comparing the image to a plurality of reference images representing the screen without the defect and determining a perturbation in the image exceeds a deviation threshold.

20. The system of claim 19, wherein the operations further comprise determining the defect using artificial intelligence, and wherein communicating the indication of the defect comprises recommending a course of action based on the defect.
